(19) United States
(12) Patent Application Publication
(10) Pub. No.: US 2019/0126630 A1
(43) Pub. Date: May 2, 2019

(54) CARTRIDGE

(71) Applicant: SEIKO EPSON CORPORATION, Tokyo (JP)

(72) Inventors: Shun OYA, Kiso-machi (JP); Taku ISHIZAWA, Matsumoto-shi (JP); Noriyuki FUKASAWA, Shiojiri-shi (JP); Tadahiro MIZUTANI, Shiojiri-shi (JP); Mao OTASHIRO, Shiojiri-shi (JP)

(73) Assignee: SEIKO EPSON CORPORATION, Tokyo (JP)

(21) Appl. No.: 16/169,771

(22) Filed: Oct. 24, 2018

(30) Foreign Application Priority Data
Oct. 30, 2017 (JP) 2017-208823
Oct. 30, 2017 (JP) 2017-208829
May 25, 2018 (JP) 2018-100258

(51) Int. Cl. B41J 2/175; B41J 2/19

(52) U.S. Cl. CPC B41J 2/17563; B41J 2/17596; B41J 2/1753; B41J 2/19; B41J 2/17523; B41J 2/17553; B41J 2/17513

(57) ABSTRACT

A cartridge includes a liquid supply portion configured to receive a liquid supply needle; a first chamber provided with a liquid absorber, a second chamber not provided with the liquid absorber and provided with the liquid supply portion; and a filter provided between the first chamber and the second chamber. A length of the filter in a longitudinal direction of the filter is longer than half a length of the liquid absorber in the longitudinal direction.

### CROSS-REFERENCE TO RELATED APPLICATIONS

The present application claims the priority based on Japanese Patent Applications No. 2017-208823 filed on Oct. 30, 2017, No. 2017-208829 filed on Oct. 30, 2017 and No. 2018-100258 filed on May 25, 2018, the disclosures of which are hereby incorporated by reference in their entirety.

### BACKGROUND

### Technical Field

The present disclosure relates to a cartridge.

### Related Art

There is known a cartridge used in a liquid jetting apparatus such as an inkjet printer in which a liquid absorber for holding liquid is disposed in a liquid storage chamber in the cartridge (see, for example, JP-A-2000-33715, JP-A-H4-173343, JP-A-2006-76313 and JP-A-2006-76314). A porous substance or a fibrous body, for example, is used as the liquid absorber. The liquid held in the liquid absorber is supplied to the liquid jetting apparatus by being taken in from a liquid supply portion provided on the bottom surface or another surface of the cartridge to the liquid jetting apparatus.

In this type of cartridge, there has been a problem in that liquid is likely to remain in a portion far from the liquid supply portion of the liquid absorber depending on the capillary force of the liquid absorber. In light of this, the inventors of the disclosure examined what would happen if a large filter was disposed between the liquid storage chamber and the liquid supply portion and liquid was made to flow through the filter in order to more easily distribute the liquid from the liquid absorber to the liquid supply portion. However, the inventors of the disclosure found that providing a cartridge with such a filter causes a problem in that, when the cartridge is subject to impact from, for example, being dropped, air on the liquid absorber side is more likely to travel to the liquid supply portion side through the filter and, as a result, the liquid may not be discharged properly.

The inventors of the disclosure also discovered another problem when providing a cartridge with such a filter. Namely, that air between the filter and the liquid supply portion expands when experiencing a rise in temperature, for example, and hence the liquid may be pushed out and leak from the liquid supply portion.

### SUMMARY

According to a first aspect of the disclosure, there is provided a cartridge which is to be mounted onto a liquid jetting apparatus that includes a liquid supply needle. The cartridge includes a liquid supply portion configured to receive the liquid supply needle; a first chamber provided with a liquid absorber; a second chamber not provided with the liquid absorber and provided with the liquid supply portion; and a filter provided between the first chamber and the second chamber. A length of the filter in a longitudinal direction of the filter is longer than half a length of the liquid absorber in the longitudinal direction.

According to a second aspect of the disclosure, there is provided a cartridge which is to be mounted onto a liquid jetting apparatus that includes a liquid supply needle. The cartridge includes a liquid supply portion configured to receive the liquid supply needle; a first chamber provided with a liquid absorber; a second chamber not provided with the liquid absorber and provided with the liquid supply portion; and a filter provided between the first chamber and the second chamber. The second chamber includes a groove portion that connects the filter to a bottom surface of the second chamber includes a liquid guising passage that guides liquid to the liquid supply portion.

According to a third aspect of the disclosure, there is provided a cartridge which is to be mounted onto a liquid jetting apparatus that includes a liquid supply needle. The cartridge includes a liquid supply portion configured to receive the liquid supply needle; a first chamber provided with a liquid absorber; a second chamber not provided with the liquid absorber and provided with the liquid supply portion; and a filter provided between the first chamber and the second chamber. The second chamber includes a groove portion that connects the filter to a bottom surface of the second chamber.

### BRIEF DESCRIPTION OF THE DRAWINGS

FIG. 1 is a perspective view for illustrating the configuration of a liquid jetting system;

FIG. 2 is a top view of the cartridge;

FIG. 3 is a perspective view of the cartridge;

FIG. 4 is a first perspective view of the cartridge;

FIG. 5 is a second perspective view of the cartridge;

FIG. 6 is an exploded perspective view of the cartridge;

FIG. 7 is a cross-sectional view taken along the line VII-VII in FIG. 2;

FIG. 8 is a cross-sectional view taken along the line VIII-VIII in FIG. 2;

FIG. 9 is a perspective view for illustrating a liquid storage chamber from a top surface side;

FIG. 10 is a plan view for illustrating the liquid storage chamber from above;

FIG. 11 is a cross-sectional view taken along the line XI-XI in FIG. 10;

FIG. 12 is a cross-sectional view taken along the line XII-XII in FIG. 10;

FIG. 13 is a cross-sectional view taken along the line XIII-XIII in FIG. 10;

FIG. 14 is a plan view for illustrating a lid member from above;

FIG. 15 is a plan view for illustrating the lid member from below;

FIG. 16 is a plan view for illustrating the lid member from a lower surface side;

FIG. 17 is a perspective view for illustrating a cross-sectional structure of the inside of the cartridge;

FIG. 18 is a perspective view for illustrating the structure of a bubble trapping chamber;

FIG. 19 is a cross-sectional view taken along the line XIX-XIX in FIG. 18;

FIG. 20 is a cross-sectional view taken along the line XX-XX in FIG. 18;

FIG. 21 is a XZ cross-sectional view of the vicinity of a liquid supply portion;

FIG. 22 is a cross-sectional view for illustrating a cartridge according to a second embodiment;

FIG. 23 is a perspective view of the cartridge illustrated in FIG. 22;

FIG. 24 is a cross-sectional view for illustrating a cartridge according to a third embodiment;

FIG. 25 is a perspective view of the cartridge illustrated in FIG. 24;

FIG. 26 is a cross-sectional view for illustrating a cartridge according to a fourth embodiment;

FIG. 27 is a perspective view of the cartridge illustrated in FIG. 26;

FIG. 28 is a cross-sectional view for illustrating a cartridge according to a fifth embodiment;

FIG. 29 is a cross-sectional view for illustrating a cartridge according to a sixth embodiment;

FIG. 30 is a perspective view for illustrating the liquid storage chamber from a top surface side;

FIG. 31 is a plan view for illustrating the liquid storage chamber from a top surface side;

FIG. 32 is an enlarged view for illustrating a groove portion as seen from the top surface side;

FIG. 33 is a perspective view of the groove portion as seen from the top surface side;

FIG. 34 is a plan view for illustrating the liquid storage chamber from a top surface side; and

FIG. 35 is an enlarged view for illustrating a welded portion.

### DESCRIPTION OF EXEMPLARY EMBODIMENTS

### A. First Embodiment

### A1. Configuration of Liquid Jetting System

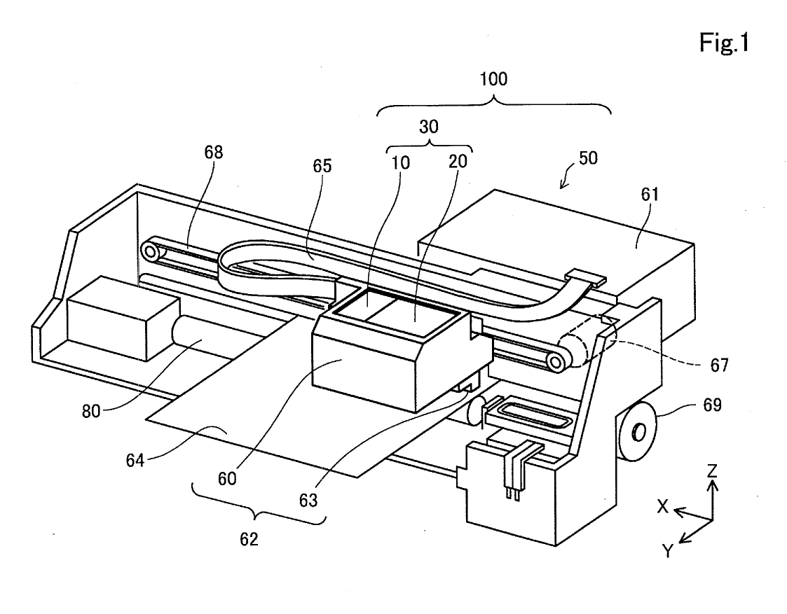

FIG. 1 is a perspective view for illustrating the configuration a liquid jetting system 100. FIG. 1 depicts XYZ-axes that are all orthogonal to each other. The XYZ-axes in FIG. 1 correspond to the XYZ-axes in other figures. The XYZ-axes are included in the following figures as necessary. The direction along the X-axis is an X-axis direction, the direction along the Y-axis is a Y-axis direction and the direction along the Z-axis is a Z-axis direction. In addition, one direction of the X-axis direction is a positive X-axis direction and another direction of the X-axis direction is a negative X-axis direction. Likewise, one direction of the Y-axis direction is a positive Y-axis direction and another direction of the Y-axis direction is a negative Y-axis direction. In addition, one direction in the X-direction is a positive X-direction and another direction in the X-direction is a negative X-direction. Moreover, one direction in the Y-direction is a positive Y-direction and another direction in the Y-direction is a negative Y-direction. In addition, one direction in the Z-direction is a positive Z-direction and another direction in the Z-direction is a negative Z-direction. Under a state in which the liquid jetting system 100 is placed on a horizontal plane that is an XY-plane parallel to the X-direction and the Y-direction, the Z-direction is an up/down direction, the positive Z-direction is an antigravity direction, that is, an up direction and the negative Z-direction is a gravity direction, that is, a down direction. In the liquid jetting system 100, the Y-direction is a front/back direction and the X-direction is a width direction, that is, a left/right direction.

The liquid jetting system 100 includes a cartridge set 30 formed of a first cartridge 10 and a second cartridge 20 and a liquid jetting apparatus 50. In the liquid jetting system 100, the two types of cartridges 10 and 20 are removably mounted to onto a cartridge holder 60 of the liquid jetting apparatus 50 by the user. The liquid jetting apparatus 50 is an inkjet printer that can print up to A3 size paper. The liquid jetting apparatus 50 includes a head 63 that can eject three or more types of liquid. In this embodiment, the head 63 can eject four different types of ink having different colors. The four different types of ink include, for example, black ink, yellow ink, magenta ink and cyan ink.

The first cartridge 10 and the second cartridge 20 are mounted onto the cartridge holder 60 along the X-direction. The first cartridge 10 stores one type of liquid. In this embodiment, the first cartridge 10 stores black ink. The second cartridge 20 stores the following three types of ink: yellow ink, magenta ink and cyan ink. In other words, the second cartridge 20 stores a plurality of types of liquid among types of liquid remaining after the one type of liquid stored in the first cartridge 10 is excluded from the three or more types of liquid that can be ejected by the head 63. Here, the number and types of cartridges that are mounted onto the cartridge holder 60 are not limited to those described in this embodiment. For example, two first cartridges 10 and one second cartridge 20 may be mounted onto the cartridge holder 60. In this case, the configuration of the cartridge holder 60 may be changed according to the number of cartridges. In addition, the types of liquid stored in the first cartridge 10 and the second cartridge 20 are not limited to those described in this embodiment. For example, the second cartridge 20 may store ink of a different color, such as light magenta or light cyan. Further, the second cartridge 20 may be configured to store 2 types of liquid or 4 types of liquid.

The liquid jetting apparatus 50 includes a control unit 61 and a carriage 62 that includes the cartridge holder 60 in addition to the cartridge holder 60. The carriage 62 includes the above-mentioned head 63. The head 63 sucks in ink through a liquid supply needle to be described later from the first cartridge 10 and the second cartridge 20 mounted onto the cartridge holder 60 and discharges the ink onto a printing medium 64 such as paper or a label. With this configuration, data such as words, figures and images are printed onto the printing medium 64.

The control unit 61 controls each unit of the liquid jetting apparatus 50. The carriage 62 is configured to move relative to the printing medium 64. The head 63 includes an ink discharging mechanism that discharges the ink supplied from the cartridges 10 and 20 mounted onto the cartridge holder 60 onto the printing medium 64. The control unit 61 and the carriage 62 are electronically connected to each other via a flexible cable 65. The ink discharging mechanism of the head 63 operates on the basis of a control signal output from the control unit 61.

In this embodiment, the carriage 62 includes the head 63 and the cartridge holder 60. In this way, the liquid jetting apparatus 50 in which the cartridge 20 is mounted onto the cartridge holder 60 on the carriage 62 that moves the head 63 is called an “on carriage” type of printer. In other embodiments, an unmovable cartridge holder 60 may be configured at a position different to the carriage 62 and the ink supplied from the cartridge 20 mounted onto the cartridge holder 60 may be supplied to the head 63 of the carriage 62 via a flexible tube. This type of printer is also called an “off carriage” type of printer.

The liquid jetting apparatus 50 includes a main scanning feed mechanism and a sub-scanning feed mechanism that move the carriage 62 and the printing medium 64 relative to each other to print on the printing medium 64. The main scanning feed mechanism of the liquid jetting apparatus 50 includes a carriage motor 67 and a drive belt 68. The main scanning feed mechanism moves the carriage 62 back and forth along the X-direction by transmitting power of the carriage motor 67 to the carriage 62 via the drive belt 68. The sub-scanning feed mechanism of the liquid jetting apparatus 50 includes a transfer motor 69 and a platen roller 80. The printing medium 64 is transferred in the positive Y-direction by transmitting power of the transfer motor 69 to the platen roller 80. The direction in which the carriage 62 moves back and forth is also referred to as a main scanning direction and a direction in which the printing medium 64 is transferred is also referred to as a sub-scanning direction. In this embodiment, the main scanning direction is the X-direction and the sub-scanning direction is the Y-direction. The carriage motor 67 of the main scanning feed mechanism and the transfer motor 69 of the sub-scanning feed mechanism operate on the basis of control signals output from the control unit 61.

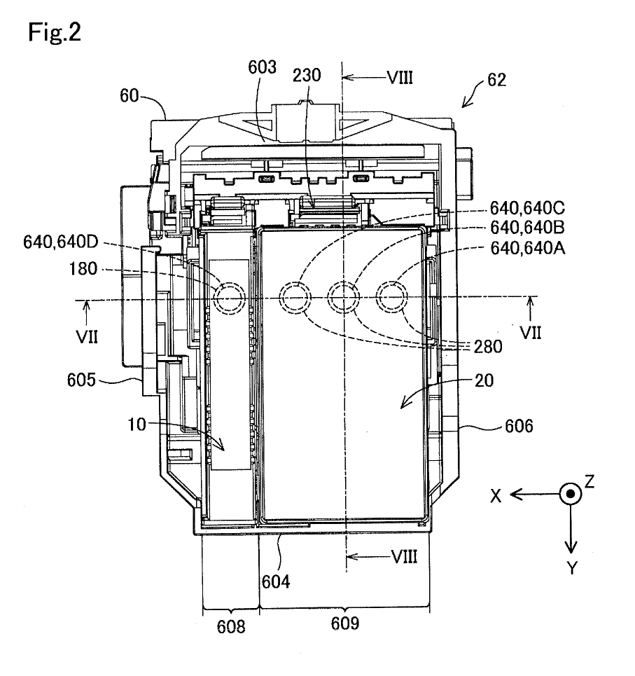

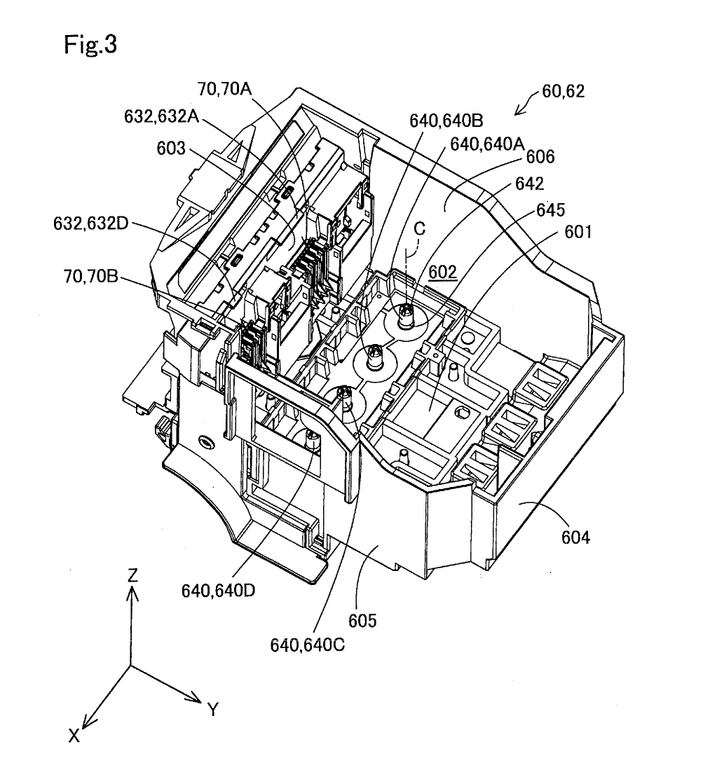

FIG. 2 is a top view for illustrating the carriage 62. FIG. 3 is a perspective view for illustrating the carriage 62. FIG. 2 illustrates the carriage 62 in a state in which the first cartridge 10 and the second cartridge 20 are mounted onto the cartridge holder 60.

As illustrated in FIGS. 2 and 3, the cartridge holder 60 includes 5 wall portions 601, 603, 604, 605, 606. A recess formed by the five wall portions 601, 603, 604, 605, 606 is a cartridge mounting portion 602 for mounting the first cartridge 10 and the second cartridge 20. As illustrated in FIG. 2, the cartridge mounting portion 602 includes a first mounting portion 608 positioned on the positive X-direction side for mounting the first cartridge 10 and a second mounting portion 609 positioned on the negative X-direction side for mounting the second cartridge 20. The cartridge mounting portion 602 is open on a top side, that is, the positive Z-direction side and the first cartridge 10 and the second cartridge 20 are mounted onto the cartridge holder 60 through this opening. The wall portion 601 is also referred to as “apparatus-side bottom wall portion 601”. The wall portion 603 is also referred to as “first apparatus-side side wall portion 603”. The wall portion 604 is also referred to as “second apparatus-side side wall portion 604”. The wall portion 605 is also referred to as “third apparatus-side side wall portion 605”. The wall portion 606 is also referred to as “fourth apparatus-side side wall portion 606”.

The apparatus-side bottom wall portion 601 forms a bottom wall of the recessed cartridge mounting portion 602. The first to fourth apparatus-side side wall portions 603, 604, 605, 606 stand up from the apparatus-side bottom wall portion 601 along the positive Z-direction to form side walls of the recessed cartridge mounting portion 602. The first apparatus-side side wall portion 603 and the second apparatus-side side wall portion 604 oppose each other in the Y-direction. The first apparatus-side side wall portion 603 is positioned on the negative Y-direction side and the second apparatus-side side wall portion 604 is positioned on the positive Y-direction side. The third apparatus-side side wall portion 605 and the fourth apparatus-side side wall portion 606 oppose each other in the X-direction. The third apparatus-side side wall portion 605 is positioned on the positive X-direction side and the fourth apparatus-side side wall portion 606 is positioned on the negative X-direction side.

As illustrated in FIG. 3, the cartridge holder 60 further includes a plurality of liquid supply needles 640 and a plurality of contact mechanisms 70 that include apparatus-side terminals. In this embodiment, four liquid supply needles 640 are provided. When the four liquid supply needles 640 are used separately, the liquid supply needles 640 are respectively denoted by the reference symbols “640A”, “640B”, “640C” and “640D”. In this embodiment, two contact mechanisms are provided. When the two contact mechanisms 70 are used separately, the contact mechanisms 70 are respectively denoted by the reference symbols “70A” and “70B”.

The liquid supply needle 640 is provided in the carriage 62, more specifically, in the cartridge mounting portion 602 in the cartridge holder 60. The liquid supply needle 640 has a flow passage that allows liquid to flow therethrough. As illustrated in FIG. 2, the liquid supply needles 640 are received by corresponding liquid supply portions 180, 280 of the first cartridge 10 and the second cartridge 20. With this configuration, the liquid stored in the first cartridge 10 and the second cartridge 20 is introduced to the flow passage inside the liquid supply needle 640. The liquid that has been introduced to the liquid supply needle 640 is supplied to the head 63.

The liquid supply needle 640 is a member that extends from the apparatus-side bottom wall portion 601 in the positive Z-direction and includes a base portion 645 and a tip portion 642. The base portion 645 side of the liquid supply needle 640 has a columnar shape and the tip portion 642 side has a substantially conical shape with an outer diameter tapered toward the positive Z-direction side. The base portion 645 forms a negative Z-direction side end portion of the liquid supply needle 640. The tip portion 642 forms a positive Z-direction side end portion of the liquid supply needle 640. The tip portion 642 is formed with an introduction hole for introducing liquid supplied from the first cartridge 10 and the second cartridge 20 to a flow passage inside the tip portion 642. The liquid supply needle 640 has a central axis C along the Z-axis direction.

As illustrated in FIG. 3, four liquid supply needles 640A to 640D are disposed in a line along the X-direction. Three of the four liquid supply needles, namely, the liquid supply needles 640A to 640C are disposed on a second mounting portion 609. The three liquid supply needles 640A to 640C are inserted into three corresponding liquid supply portions 280 that each include a second cartridge 20, respectively. With this configuration, liquids of different types stored in the second cartridges 20 flow through the three liquid supply needles 640A to 640C. In this embodiment, yellow ink flows through the liquid supply needle 640A, magenta ink flows through the liquid supply needle 640B and cyan ink flows through the liquid supply needle 640C. One of the four liquid supply needles 640, namely, the liquid supply needle 640D is inserted into one liquid supply portion 280 that includes the first cartridge 10. With this configuration, the liquid (in this embodiment, black ink) that is stored in the first cartridge 10 flows through the liquid supply needle 640D.

The contact mechanisms 70 are disposed on the first apparatus-side side wall portion 603. A contact mechanism 70A includes an apparatus-side terminal group that makes contact with a contact portion cp on a circuit board 400 provided in the second cartridge 20 under a mounting state in which the second cartridge 20 is mounted onto the second mounting portion 609. A contact mechanism 70B includes an apparatus-side terminal group that makes contact with a contact portion on a circuit board provided on the first cartridge 10 under a mounting state of the first cartridge 10.

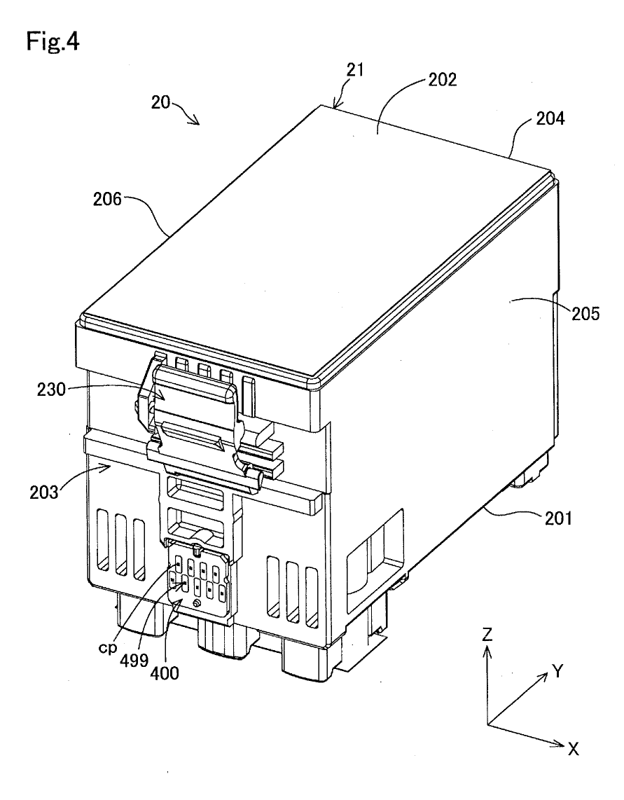

The cartridge holder 60 further includes apparatus-side engagement portions 632. The apparatus-side engagement portions 632 are disposed on the first apparatus-side side wall portion 603 closer to the positive Z-direction side than the contact mechanisms 70. Two apparatus-side engagement portions 632 are provided. When the two apparatus-side engagement portions 632 are used separately, the apparatus-side engagement portions 632 are respectively denoted by the reference symbols “632A” and “632D”. The apparatus-side engagement portion 632 is a protruding piece that protrudes from the first apparatus-side side wall portion 603 toward the cartridge mounting portion 602 side, that is, the positive Y-direction side. An apparatus-side engagement portion 632A provided on the second mounting portion 609 engages with an engaging member 230 of the second cartridge 20 illustrated in FIG. 4 under the mounting state of the second cartridge 20. An apparatus-side engagement portion 632D provided on the first mounting portion 608 engages with an engaging member of the first cartridge 10 under the mounting state of the first cartridge 10.

### A2. Configuration of Cartridge

Various types of cartridges with different configurations can be applied as the first cartridge 10. In this embodiment, a cartridge having the configuration described in Japanese Patent Unexamined Publication 2013-248786 is used as the first cartridge 10. Characteristics of the second cartridge 20 are described in detail below. Note that in the following description, the second cartridge 20 is sometimes simply referred to as “cartridge 20”.

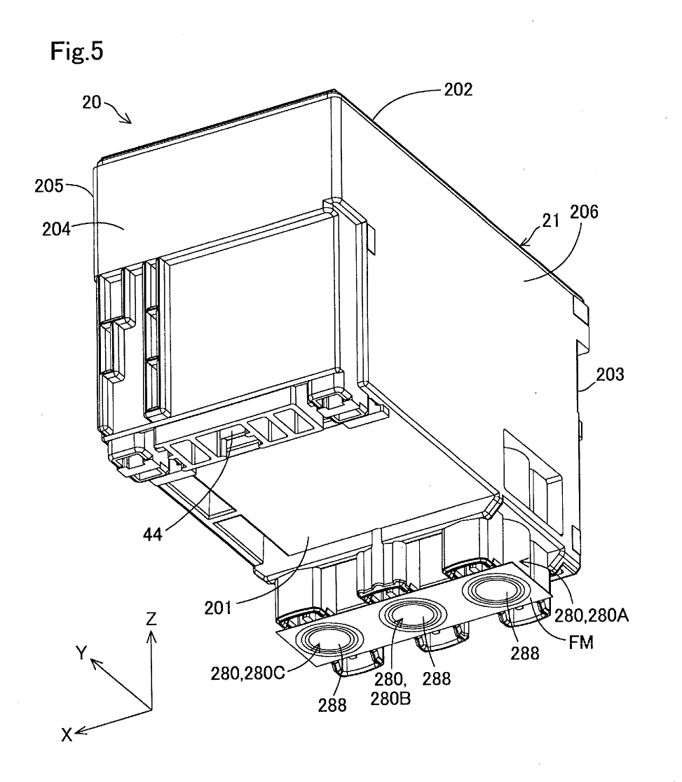

FIG. 4 is a first perspective view of the cartridge 20. FIG. 5 is a second perspective view of the cartridge 20. Length of the cartridge 20 as a dimension of the cartridge 20 in the Y-direction, width of the cartridge 20 as a dimension of the cartridge 20 in the X-direction and height of the cartridge 20 as a dimension of the cartridge 20 in the Z-direction are larger in size in the order of length, height and width. Further, the cartridge 20 is wider than the first cartridge 10. Note that the relationship between the magnitudes of the length, width and height of the cartridge 20 can be arbitrarily changed and, for example, may be larger in the order of height, length and width or the height, length and width may all be equal to each other.

The external appearance of the cartridge 20 looks substantially like a cuboid. The cartridge 20 has six surfaces. The six surfaces are a bottom surface 201, a top surface 202, a first side surface 204, a second side surface 203, a third surface 205 and a fourth side surface 206. The first side surface is also referred to as a front surface, the second side surface is also referred to as a rear surface, the third side surface is also referred to as a left side surface and the fourth side surface is also referred to as a right side surface. The six surfaces 201 to 206 form a housing 21 of the cartridge 20. Each surface 201 to 206 has a flat shape. A flat shape includes both a case where the entire surface is flat and a case where part of the surface is uneven. As illustrated in FIG. 5, a portion formed with the liquid supply portion 280 and an air communication port 44 to be described later protrudes from the bottom surface 201. The outer shape of each surface 201 to 206 when viewed in plan is a substantially rectangular shape.

The bottom surface 201 is a concept that includes a wall that forms the bottom wall of the cartridge 20 in the mounting state and can also be referred to as “bottom wall 201”. Further, the top surface 202 is a concept that includes a wall that forms the top wall of the cartridge 20 in the mounting state and can also be referred to as “top wall 202”. The first side surface 204 is a concept that includes a wall that forms a front surface wall of the cartridge 20 in the mounting state and can also be referred to as “front surface wall 204”. Further, the second side surface 203 is a concept that includes a wall that forms a rear surface wall of the cartridge 20 in the mounting state and can also be referred to as “rear surface wall 203”. The third side surface 205 is a concept that includes a wall that forms a left side wall in the mounting state and can also be referred to as “left side surface wall 205”. The fourth side surface 206 is a concept that includes a wall that forms a right side wall in the mounting state and can also be referred to as “right side surface wall 206”. Note that a “wall” does not need to be formed of a single wall and may be formed of a plurality of walls.

The bottom surface 201 and the top surface 202 oppose each other in the Z-direction. The bottom surface 201 is positioned on the negative Z-direction side and the top surface 202 is positioned on the positive Z-direction side. In the mounting state, the bottom surface 201 faces to the apparatus-side bottom wall portion 601 of the cartridge holder 60 illustrated in FIG. 3. The bottom surface 201 and the top surface 202 are horizontal surfaces in the mounting state. The bottom surface 201 and the top surface 202 substantially orthogonally intersect with the first side surface 204, the second side surface 203, the third side surface 205 and the fourth side surface 206. The bottom surface 201 and the top surface 202 are surfaces parallel to the X-direction and the Y-direction. The bottom surface 201 and the top surface 202 are surfaces orthogonal to the Z-direction. When a surface parallel to the X-direction and the Y-direction and orthogonal to the Z-direction is determined as an XY-horizontal surface, the bottom surface 201 and the top surface 202 are parallel surfaces parallel to the XY-horizontal surface. Note that, in this embodiment, two surfaces “meeting” or “intersecting” refers to any one of the following states: a state where the two surfaces intersect by being connected to each other, a state where one surface intersects with the other surface by being extended and a state where the surfaces intersect with each other by both being extended. In addition, two surfaces “opposing each other” includes both a case where nothing exists between the two surfaces and a case where something exists between the two surfaces.

The first side surface 204 and the second side surface 203 oppose each other in the Y-direction. The first side surface 204 is positioned on the positive Y-direction side and the second side surface 203 is positioned on the negative Y-direction side. In the mounting state, the first side surface 204 faces the second apparatus-side side wall portion 604 of the cartridge holder 60 illustrated in FIG. 3. The second side surface 203 faces the first apparatus-side side wall portion 603 of the cartridge holder 60 illustrated in FIG. 3. The first side surface 204 and the second side surface 203 are perpendicular surfaces in the mounting state. The first side surface 204 and the second side surface 203 intersect the bottom surface 201, the top surface 202, the third side surface 205 and the fourth side surface 206 at substantially a right angle. The first side surface 204 and the second side surface 203 are surfaces parallel to the X-direction and the Z-direction. The first side surface 204 and the second side surface 203 are surfaces that intersect with the Y-direction. When a surface parallel to the X-direction and the Z-direction and orthogonal to the Y-direction is determined as an XZ-horizontal surface, the first side surface 204 and the second side surface 203 are parallel surfaces parallel to the XZ-horizontal surface.

The third side surface 205 and the fourth side surface 206 oppose each other in the X-direction. The third side surface 205 is positioned on the positive X-direction side and the fourth side surface 206 is positioned on the negative X-direction side. In the mounting state, the third side surface 205 faces the first cartridge 10. In the mounting state, the fourth side surface 206 faces the fourth apparatus-side side wall portion 606 of the cartridge holder 60 illustrated in FIG. 3. The third side surface 205 and the fourth side surface 206 intersect the bottom surface 201, the top surface 202, the first side surface 204 and the second side surface 203 at substantially a right angle. The third side surface 205 and the fourth side surface 206 are surfaces parallel to the Y-direction and the Z-direction. The third side surface 205 and the fourth side surface 206 are surfaces orthogonal to the X-direction. When a surface parallel to the Y-direction and the Z-direction and orthogonal to the X-direction is determined as an YZ-horizontal surface, the third side surface 205 and the fourth side surface 206 are surfaces parallel to the YZ-horizontal surface.

As illustrated in FIG. 4, the cartridge 20 includes the circuit board 400 and the lever-shaped engaging member 230 that engages with the apparatus-side engagement portion 632A on the second side surface 203. A surface of the circuit board 400 is provided with a cartridge-side terminal group 499. The cartridge-side terminal group 499 includes a contact portion cp that makes contact with the contact mechanisms 70 provided on the mounting portion 602. A rear surface of the circuit board 400 is provided with a storage device that is electronically connected to the cartridge-side terminal group 499. The storage device stores information on the cartridge 20. The information on the cartridge 20 is, for example, information on the type of stored liquid, information on the amount of stored liquid, information on a consumption amount of the liquid and information on the manufacturing date of the cartridge 20. The control unit 61 provided in the liquid jetting apparatus 50 can read this information from the storage device provided to the circuit board 400 using the contact mechanisms 70 and the cartridge-side terminal group 499.

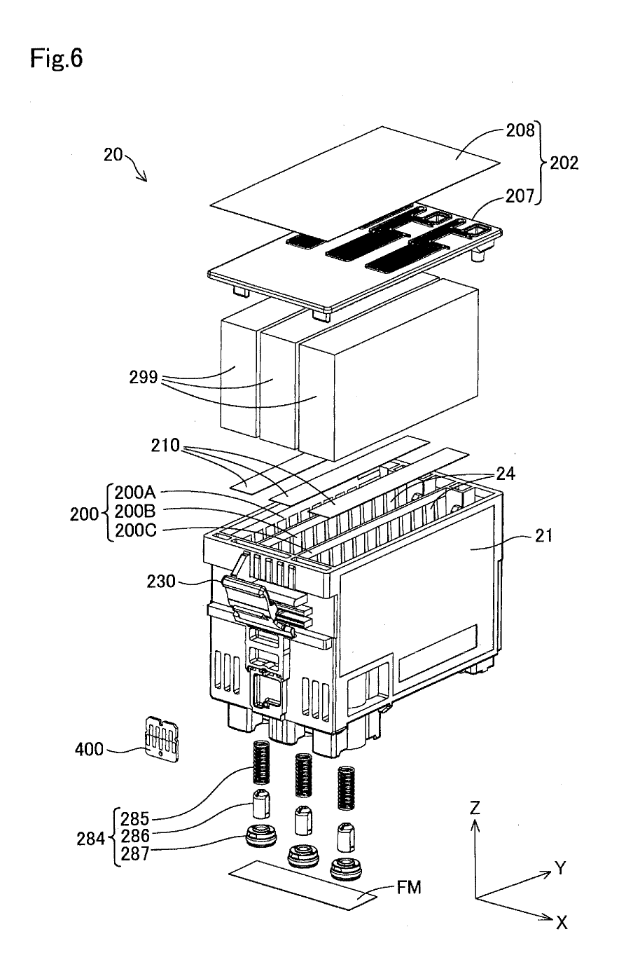

FIG. 6 is an exploded perspective view of the cartridge 20. A plurality of liquid storage compartments 200A, 200B, 200C that each store one type of the above-mentioned plurality of types of liquid is provided in the housing 21 of the cartridge 20. The three liquid storage compartments 200A to 200C are divided by side walls 24 provided in the housing 21 along a YZ-horizontal plane so that the different types of liquid do not mix with each other. The liquid storage chamber 200A stores yellow ink, the liquid storage chamber 200B stores magenta ink and the liquid storage chamber 200C stores cyan ink. For example, each of the plurality of types of liquid stored in the cartridge 20 is a dye ink. A filter 210 is fixed to the bottom portion of the liquid storage chamber 200A, 200B, 200C and a cuboid liquid absorber 299 is disposed on the filter 210. The liquid absorber 299 is a member for holding or absorbing liquid using predetermined capillary strength. The liquid absorber 299 may be a foam member such as polyurethane foam or a fibrous member in which polypropylene manufactured into a fibrous state is bound. The top surface 202 of the housing 21 of the cartridge 20 is formed of a lid member 207 and a top surface film member 208 affixed onto the lid member 207. Herein, the phrase “liquid storage chamber 200” is used when the liquid storage chamber 200A, the liquid storage chamber 200B and the liquid storage chamber 200C are not particularly distinguished from one another. Note that, in this embodiment, the cartridge 20 includes three liquid storage compartments 200, but the cartridge 20 may include two liquid storage compartments 200 or four or more liquid storage compartments 200.

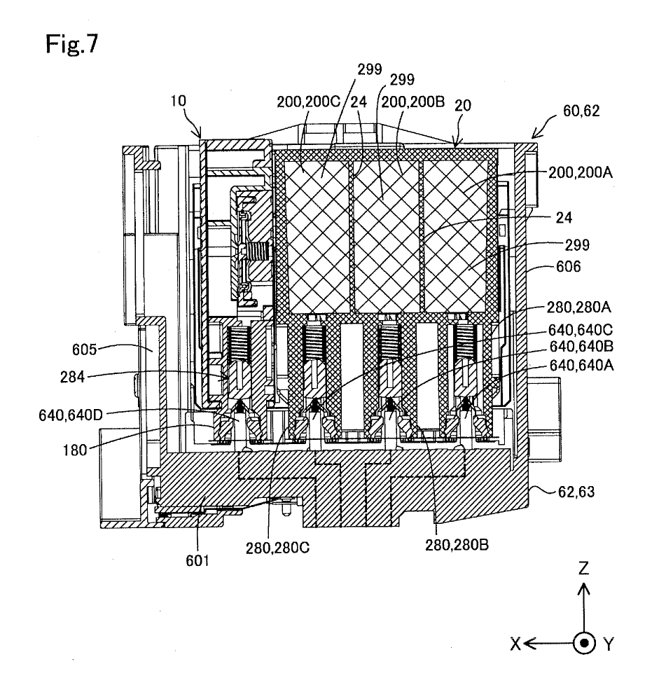

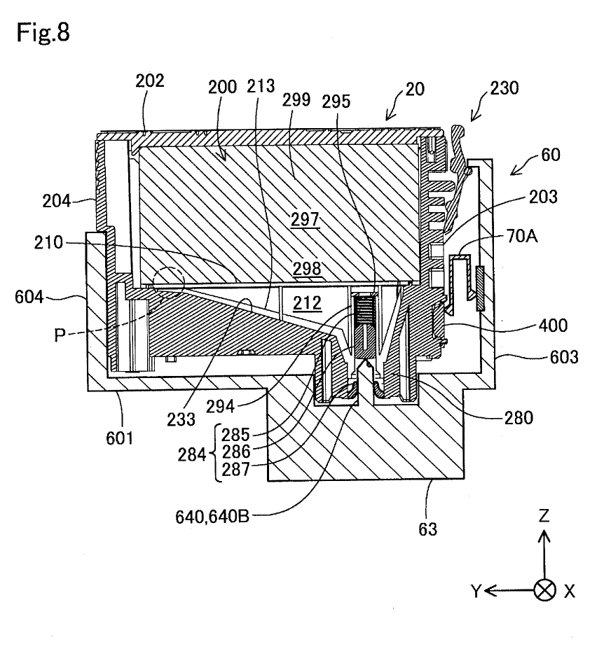

FIG. 7 is a cross-sectional view taken along the line VII-VII in FIG. 2. FIG. 8 is a cross-sectional view taken along the line VIII-VIII in FIG. 2. FIG. 8 illustrates a cross-sectional structure in the vicinity of the liquid storage chamber 200A, but the cross-sectional structures in the vicinity of the liquid storage chamber 200B and the liquid storage chamber 200C are substantially the same as the cross-sectional structure in the vicinity of the liquid storage chamber 200A. As illustrated in FIG. 7, when the first cartridge 10 is mounted onto the cartridge holder 60, the liquid supply needle 640D is inserted into the liquid supply portion 280 of the first cartridge 10. With this configuration, black ink is supplied from the first cartridge 10 to the head 63 via the liquid supply needle 640D. The first cartridge 10 does not have a liquid absorber for holding or absorbing ink. In other words, the first cartridge 10 is a direct-ink cartridge.

As illustrated in FIG. 8, the cartridge 20 includes a liquid storage chamber 200 provided with the liquid absorber 299, the liquid supply portion 280, a bubble trapping chamber 212 provided on the liquid supply portion 280 and the thin filter 210. The liquid supply portion 280 is a portion for receiving the liquid supply needle 640 and supplying the ink inside the liquid storage chamber 200 to the liquid jetting apparatus 50. The liquid supply portion 280 is positioned closer to the second side surface 203 than the first side surface 204 in the Y-direction. In the mounting state, the bubble trapping chamber 212 is positioned directly below the liquid storage chamber 200. The filter 210 is provided between the liquid storage chamber 200 and the bubble trapping chamber 212. The filter 210 is formed of, for example, a PET nonwoven fabric or a stainless-steel nonwoven fabric. In this embodiment, the filter 210 is arranged along the horizontal direction in the mounting state. Note that a liquid absorber is not provided in the bubble trapping chamber 212. The liquid storage chamber 200 is also referred to as “first chamber” and the bubble trapping chamber 212 is also referred to as “second chamber”.

The majority of the bubble trapping chamber 212 and the liquid storage chamber 200 is filled with ink when beginning to use the cartridge 20. When the ink in the liquid storage chamber 200 and the bubble trapping chamber 212 is used via the liquid supply portion 280, air is introduced into the liquid storage chamber 200 from an air communication passage 40 to be described later. In other words, the cartridge 20 of this embodiment is an air-release cartridge.

The bubble trapping chamber 212 has a function of supplying the liquid stored in the liquid storage chamber 200 to the liquid supply portion 280 and a function of trapping bubbles. The bubble trapping chamber 212 stores (1) bubbles that have entered from the liquid storage chamber 200 via the filter 210 during impact such as being dropped; (2) bubbles that have entered through the liquid supply portion 280 when the liquid supply portion 280 receives the liquid supply needle 640; and (3) bubbles that have expanded inside the bubble trapping chamber 212. In this embodiment, because the bubbles that have been generated or infiltrated the system due to some reason are stored in the bubble trapping chamber 212, problems when supplying the liquid can be minimized.

As illustrated in FIGS. 7 and 8, under the mounting state of the cartridge 20, a corresponding liquid supply needle 640 is inserted into the liquid supply portion 280 of the cartridge 20. With this configuration, yellow ink, magenta ink and cyan ink are supplied from the liquid storage chamber 200 and the bubble trapping chamber 212 to the head 63 via the liquid supply needle 640.

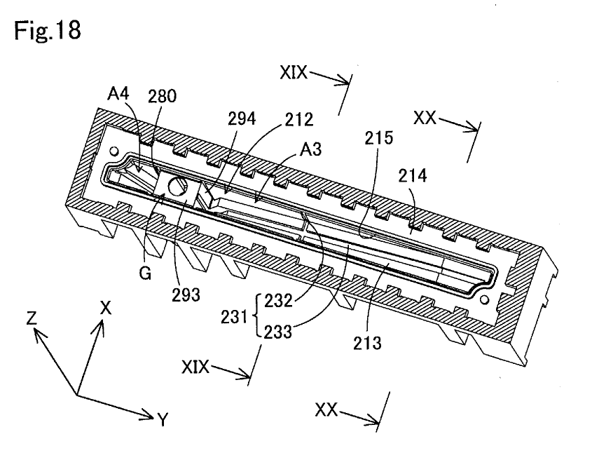

As illustrated in FIGS. 6 to 8, the liquid supply portion 180 and the liquid supply portions 280A to 280C each include a valve mechanism 284. The valve mechanism 284 opens and closes internal flow passages in the liquid supply portion 180, 280. The valve mechanism 284 includes, in order from a tip edge side of the liquid supply portion 180, 280, a sealing portions 287, a valve element 286 that opens by making contact with the liquid supply needle 640 and a biasing member 285 configured to close the valve element 286. The liquid supply portion 280 includes the valve chamber 294 illustrated in FIG. 18. The valve element 286 and the biasing member 285 are disposed in the valve chamber 294.

The sealing portion 287 is a substantially annular member. The sealing portion 287 is configured of an elastic body such as rubber or an elastomer. The sealing portion 287 is press-fitted inside the liquid supply portion 180, 280 from a tip opening of the liquid supply portion 180, 280. In the mounting state, the sealing portion 287 makes air-tight contact with the outer peripheral surface of the liquid supply needle 640, to thereby prevent liquid from leaking to the outside from a gap between the liquid supply portion 180, 280 and the liquid supply needle 640. The sealing portion 287 also functions as valve seat that makes contact with the valve element 286 when the valve element 286 is closed.

The valve element 286 is a substantially cylindrical member. In a pre-mounting state in which the cartridge 10, 20 is yet which is mounted onto the cartridge holder 60, the valve element 286 is biased by the biasing member 285 toward a direction toward the sealing member 287 and covers a hole formed in the sealing member 287. In other words, in the pre-mounting state, the valve mechanism 284 is closed.

The biasing member 285 is a compression coil spring. In the mounting state of the cartridge 10, 20, the liquid supply needle 640 presses the valve element 286 toward a direction away from the sealing portion 287, to thereby compress the biasing member 285 and separate the valve element 286 from the sealing portion 287. With this configuration, the valve mechanism 284 opens. An end portion of the biasing member 285 on the positive Z-direction side makes contact with a wall 295 of the valve chamber 294 on the positive Z-direction side. Therefore, when the biasing member 285 is compressed, the valve chamber 294 restricts movement of the biasing member 285 toward the positive Z-direction side.

In the pre-use state of the cartridge 20, the tip opening 288 of the liquid supply portion 280 is covered by the film FM illustrated in FIGS. 5 and 6. The film FM is configured to be broken by the liquid supply needle 640A, 640B, 640C when the cartridge 20 is mounted onto the second mounting portion 609 of the cartridge holder 60.

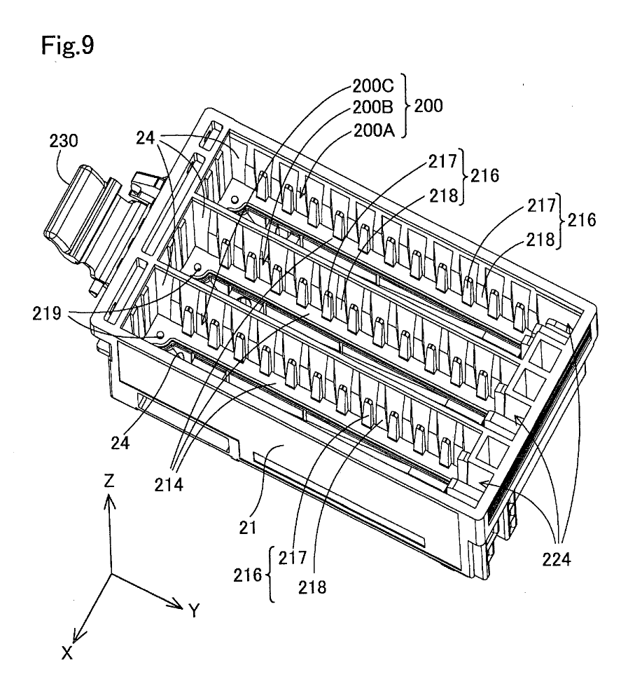

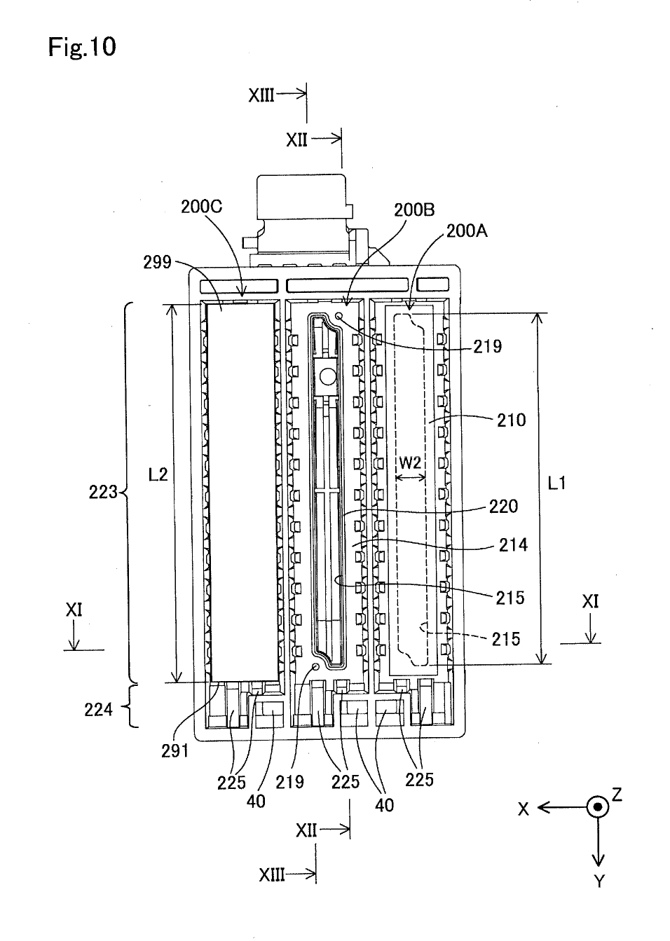

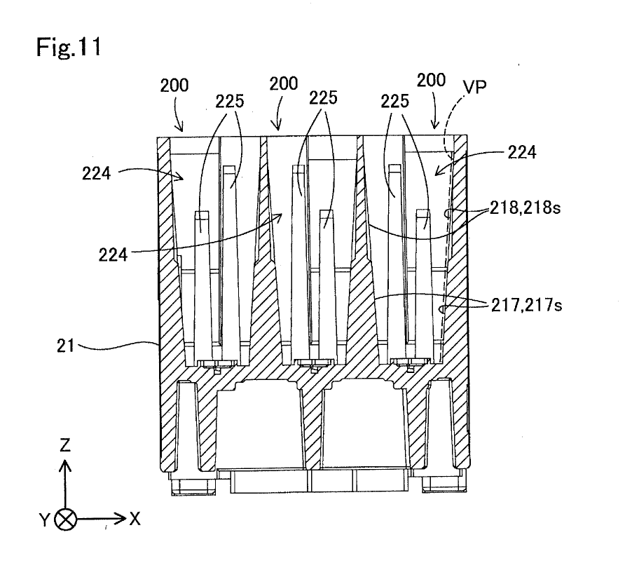

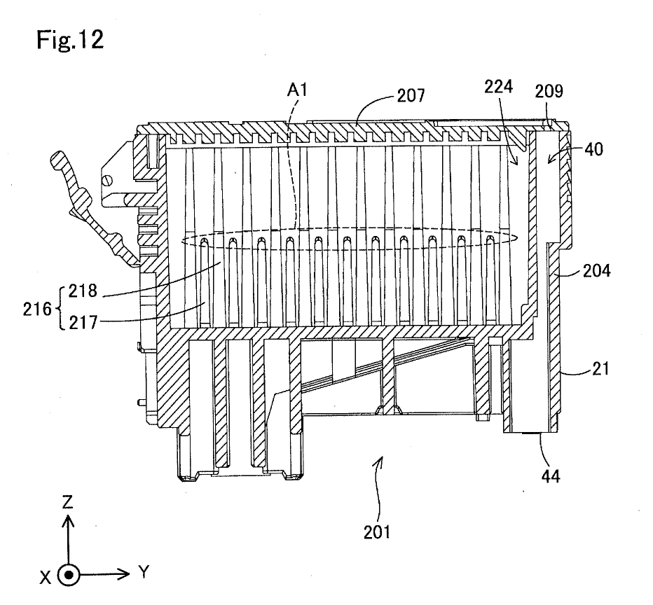

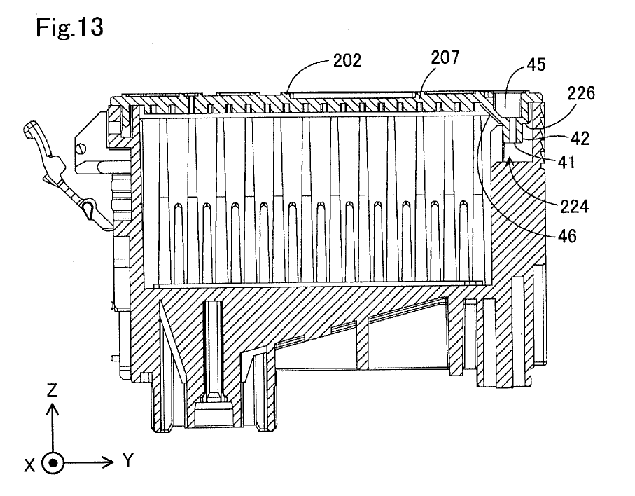

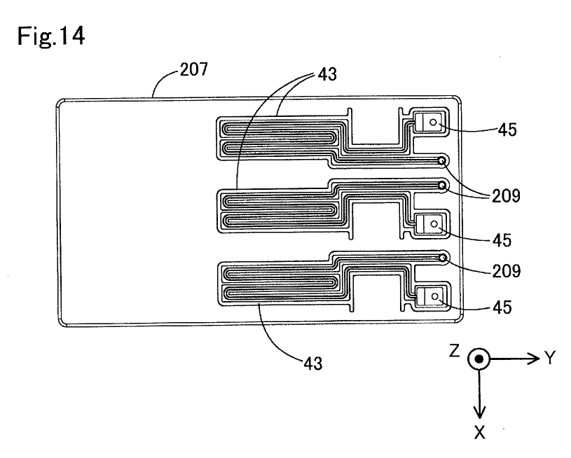

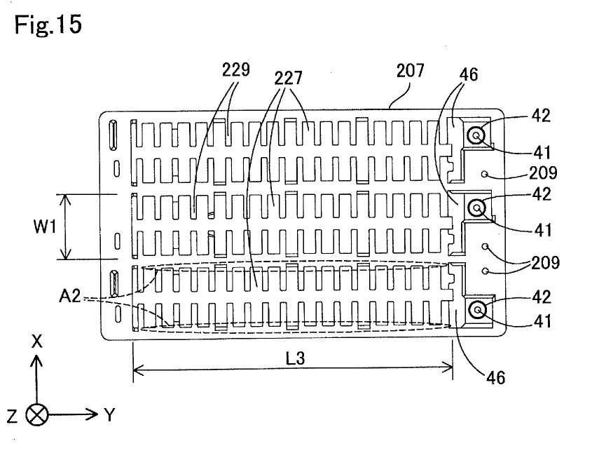

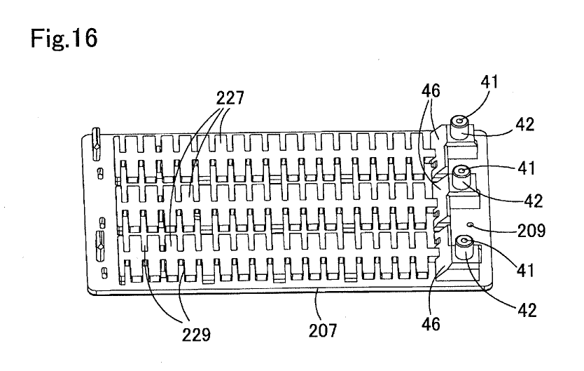

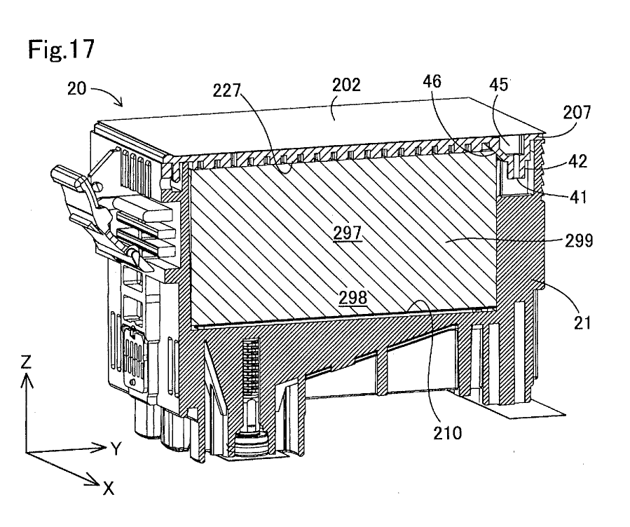

FIG. 9 is a perspective view for illustrating the liquid storage chamber 200 from a top surface side. FIG. 10 is a plan view for illustrating the liquid storage chamber 200 from above. FIG. 11 is a cross-sectional view taken along the line XI-XI in FIG. 10. FIG. 12 is a cross-sectional view taken along the line XII-XII in FIG. 10. FIG. 13 is a cross-sectional view taken along the line XIII-XIII in FIG. 10. FIG. 14 is a plan view for illustrating the lid member 207 from above. FIG. 15 is a plan view for illustrating the lid member 207 from below. FIG. 16 is a plan view for illustrating the lid member 207 from a lower surface side. FIG. 17 is a perspective view for illustrating a cross-sectional structure of the inside of the cartridge 20. Note that while FIG. 10 does not illustrate the lid member 207, FIGS. 12 and 13 which illustrate cross-sections of FIG. 10 illustrate cross-sections of the lid member 207.

As illustrated in FIG. 9, a convex portion 216 that protrudes inward toward the liquid storage chamber 200 is provided on the side surface 24 of the liquid storage chamber 200. One convex portion 216 is provided on each inner surface of the pair of side walls 24 that oppose each other in the X-direction. The convex portion 216 extends in the Z-direction, which is an up/down direction. The convex portion 216 includes a portion that is more sharply inclined as the convex portion 216 protrudes further from a top portion of the liquid storage chamber 200 toward the bottom portion 214 of the liquid storage chamber 200. Note that, in this embodiment, the “bottom portion 214” of the liquid storage chamber 200 is more specifically a bottom portion of an absorber chamber 223 which a portion of the liquid storage chamber 200 where the liquid absorber 299 is disposed.

The convex portion 216 includes a plurality of first convex portions 217 and a plurality of second convex portions 218. The second convex portion 218 is taller than the first convex portion 217 in the up/down direction. In other words, the first convex portion 217 is shorter than the second convex portion 218 in the up/down direction. In addition, a portion of the second convex portion 218 that is lower than first convex portion 217 protrudes less inward toward the liquid storage chamber 200 than the first convex portion 217. The plurality of first convex portions 217 and the plurality of second convex portions 218 are alternately arranged on the side wall 24 of the liquid storage chamber 200 with intervals between the portions in the Y-direction, which is a direction that intersects with the Z-direction as the up/down direction. As illustrated in FIG. 11, a surface 217s of the first convex portion 217 that faces an inner side of the liquid storage chamber 200 and a surface 218s of the second convex portion 218 that faces an inner side of the liquid storage chamber 200 at a portion taller than the first convex portion 217 are both located on substantially the same virtual plane VP. On the virtual plane VP, the second convex portion 218 protrudes slightly less and a small step is formed at a boundary portion between the first convex portion 217 and the second convex portion 218.

With the above-described configuration of the convex portion 216, the cross-sectional area of the internal of the liquid storage chamber 200 is smaller on the bottom portion 214 side of the liquid storage chamber 200 than the upper portion side of the liquid storage chamber 200. Therefore, the liquid absorber 299 disposed in the liquid storage chamber 200 is compressed from the upper surface side to the bottom surface side of the liquid storage chamber 200. Note that in this embodiment, the cross-sectional area of the upper portion side of the liquid storage chamber 200 is reduced on the bottom portion 214 side by inclining the convex portion 216, but the cross-sectional area of the bottom portion 214 side can be made smaller than the upper portion side of the liquid storage chamber 200 by inclining the side wall 24.

In this embodiment, small spaces are formed between the liquid absorber 299 and the side wall 24 due to the convex portions 216 making contact with the liquid absorber 299. These spaces are connected to each other between the first convex portion 217 and the second convex portion 218 that have different heights and communicate until an air chamber 224 to be described later. In other words, in this embodiment, as illustrated in FIG. 12, a space A1 through which air or ink can flow until the air chamber 224 is formed between the liquid absorber 299 and the side wall 24 due to the convex portions 216 being formed on the side wall 24 of the liquid storage chamber 200.

In FIG. 10, the filter 210 is disposed in the liquid storage chamber 200A, the liquid absorber 299 is disposed in the liquid storage chamber 200C, and neither the filter 210 nor the liquid absorber 299 are disposed in the liquid storage chamber 200B. The shape of the bottom portion 214 of the liquid storage chamber 200 is a substantially rectangular shape having a longitudinal direction and a transverse direction. The longitudinal direction follows the Y-direction and the transverse direction follows the X-direction. Corners of the rectangular-shaped bottom portion 214 may be chamfered. A large opening 215 is formed in the bottom portion 214 of the liquid storage chamber 200. The opening 215 allows the liquid storage chamber 200 to communicate with the bubble trapping chamber 212. The filter 210 is disposed between the liquid storage chamber 200 and the bubble trapping chamber 212 so as to cover the opening 215. The liquid storage chamber 200 and the bubble trapping chamber 212 are partitioned by the filter 210. In this embodiment, the capillary strength of the filter 210 is stronger than the capillary strength of any portion of the liquid absorber 299.

The filter 210 has a rectangular outer shape that is larger than the opening 215. A positioning protrusion 219 for positioning the filter 210 is formed on the bottom surface 214 of the liquid storage chamber 200. In this embodiment, one positioning protrusion 219 is provided on each diagonal corner portion at either end of the opening 215 in the Y-direction which is a longitudinal direction. When the filter 210 is fixed to the bottom portion 214 of the liquid storage chamber 200, the filter 210 is first temporarily welded onto the positioning protrusion 219 outside of the opening 215. Then, the filter 210 is welded onto a welding portion 220 provided on the outer periphery of the opening 215. The welded portion 220 has a convex shape toward the filter 210.

As illustrated in FIG. 10, in this embodiment, the outer shape of the filter 210 is bigger than that of the opening 215. However, in the following description, the size of the filter 210 is not the size of the outer shape of the filter 210 and is the size of a portion at which the filter 210 performs its function as a filter, that is, a portion corresponding to the opening 215. Note that “size of the filter 210” includes the length, width, area and other aspects of the filter 210.

In this embodiment, the maximum length L1 of the filter 210 along the Y-direction which is the longitudinal direction is longer than half a length L2 of the liquid absorber 299 along the longitudinal direction of the filter 210. In other words, a ratio of the length L1 of the filter 210 to the length L2 of the liquid absorber 299 is 50% or more. This ratio is preferably 75% or more and further preferably 90% or more. In addition, this ratio may be 100%. In this embodiment, the ratio is 93%.

In this embodiment, the shortest distances from the outermost periphery of the opening 215 to the outer periphery of the bottom portion 214 in both the Y-direction which is the longitudinal direction of the filter 210 and the X-direction which is the transverse direction of the filter 210 are substantially equal. Therefore, ink can be prevented from existing on only one of either end portion of the bottom portion 214 in both the longitudinal direction and the transverse direction.

The liquid storage chamber 200 includes an absorber chamber 223 provided with the liquid absorber 299 and the air chamber 224 not provided with the liquid absorber 299. The absorber chamber 223 and the air chamber 224 are arranged in a row in the horizontal direction. More specifically, the absorber chamber 223 and the air chamber 224 are arranged in a row in the Y-direction which is the longitudinal direction of the filter 210. The filter 210 and the opening 215 are disposed in the absorber chamber 223 of the liquid storage chamber 200 but not disposed on the air chamber 224 of the liquid storage chamber 200.

In this embodiment, at least one portion of the side surface 219 of the liquid absorber 299 adjacent to the air chamber 224 makes contact with air inside the air chamber 224. Another portion of the side surface 291 of the liquid absorber 299 makes contact with a portioning rib 225 provided in the air chamber 224 in the up/down direction. The portioning rib 225 restricts the liquid absorber 299 in the absorber chamber 223 from moving toward the air chamber 224. As illustrated in FIG. 11, the height of the partitioning rib 225 along the up/down direction is shorter than the height of the internal space inside the liquid storage chamber 200. Therefore, the partitioning rib 225 cannot prevent air from flowing through the air chamber 224. In addition, a plurality of the partitioning ribs 225 is provided inside one air chamber 224 and each partitioning rib 225 has a different length in the up/down direction.

As illustrated in FIG. 13, a connection port 41 that connects the air chamber 224 and the air communication passage 40 to each other is provided on a top portion of the air chamber 224. In this embodiment, the connection port 41 is provided on a tip end of a cylindrical tube 42 that protrudes downward from a ceiling surface 226 of the air chamber 224. The tube 42 is formed on a lower surface of the lid member 207 that forms the top surface 202 of the liquid storage chamber 200. The tube 42 communicates with the top surface side of the lid member 207. The air communication passage 40 connected to the connection port 41 is a passage for connecting the liquid storage chamber 200 with air outside the housing 21 and is provided inside the housing 21. As illustrated in FIG. 12, the air communication passage 40 extends from a top surface side of the housing 21 to a bottom surface side of the housing 21. The air communication passage 40 penetrates the first side surface 204 of the cartridge 20 in the up/down direction. An air communication port 44 which is a port for connecting the air communication passage 40 and air is provided on the bottom surface 201 of the housing 21 bottom surface 201.

As illustrated in FIG. 14, thin and complex winding flow passages are formed on the top surface of the lid member 207 on top of the liquid storage chamber 200. These flow passages are referred to as “winding flow passages 43”. The winding flow passages 43 are divided by grooves formed in the top surface of the lid member 207 and the top surface film member 208 illustrated in FIG. 6 that is affixed to the top surface of the lid member 207. One end of the winding flow passages 43 communicates with the tube 42 illustrated in FIG. 13 through a concave portion 45 provided on the top surface of the lid member 207. Another end of the winding flow passages 43 communicates with the air communication passage 40 illustrated in FIG. 12 via through holes 209 provided in the lid member 207. Therefore, the air chamber 224 and the air communication passage 40 are connected to each other via the winding flow passages 43. Note that the winding flow passages 43 can also be considered to form a part of the air communication passage 40 because the winding flow passages 43 connect the air chamber 224 and the air communication passage 40 to each other.

The winding flow passages 43 are long from the liquid storage chamber 200 to the communication port 44, and hence ink in the liquid storage chamber 200 can be prevented from evaporating and being discharged from the air communication port 44. In addition, because the winding flow passages 43 that form part of the air communication passage 40 are formed so as to be thin, the winding flow passages 43 have constant capillary strength in terms of the ink. Therefore, even if the ink were to enter the winding flow passages 43, the ink can be prevented from being discharged from the air communication port 44 through the winding flow passages 43 as the air communication passage 40. In addition, in this embodiment, even if the ink were to flow back into the tube 42, the ink would temporarily accumulate in the concave portion 45 between the winding flow passages 43 and the tube 42. Therefore, the ink can be prevented from entering the winding flow passages 43.

In this embodiment, as illustrated in FIGS. 15 and 16, a step portion 227 that protrudes downward is formed on a lower surface of the lid member 207 that forms the ceiling surface 226 of the liquid storage chamber 200 at a portion corresponding to the absorber chamber 223. A lower surface of the step portion 227 is flat. The step portion 227 has a substantially rectangular shape when viewed from the lower surface. The step portion 227 makes contact with the top surface of the liquid absorber 299 to compress the liquid absorber 299 toward the bottom portion 214 of the liquid storage chamber 200. With this configuration, the bottom surface portion 298 of the liquid absorber 299 illustrated in FIGS. 8 and 17 is pushed into the filter 210, holes in the bottom surface portion 298 of the liquid absorber 299 become smaller, and the capillary force of the bottom surface portion 298 increases to more than the capillary force of a central portion 297 of the liquid absorber 299 in a height direction. Note that the portion at which the holes in the bottom surface portion 298 of the liquid absorber 299 become smaller has a thickness of a few ten μm or more. In this embodiment, because the step portion 227 makes contact with the top surface of the liquid absorber 299, ink that has accumulated around the lid member 207 can be reabsorbed by the liquid absorber 299 at the position of contact if the cartridge 20 has been turned upside-down.

In this embodiment, a maximum width W1 illustrated in FIG. 15 of the step portion 227 along the X-direction, which is the transverse direction of the filter 210, is larger than a maximum width W2 illustrated in FIG. 10 of the filter 210 along the transverse direction of the filter 210. Further, in this embodiment, a maximum length L3 illustrated in FIG. 15 of the step portion 227 along the Y-direction, which is the longitudinal direction of the filter 210, is longer than the maximum length L1 illustrated in FIG. 10 of the filter 210 along the longitudinal direction of the filter 210. In other words, in this embodiment, the step portion 227 is larger than the filter 210. Therefore, the liquid absorber 299 can be favorably compressed toward the filter 210. Note that, in this embodiment, as illustrated in FIGS. 15 and 16, a plurality of streak-shaped notches 229 are formed in the step portion 227 from the positive X-direction to the negative X-direction. These notches 229 can minimize the occurrence of sinking when the lid member 207 is manufactured. Note that the notches 229 may be omitted.

In this embodiment, under a state in which the step portion 227 makes contact with the top surface of the liquid absorber 299, the small space A2 illustrated in FIG. 15 exists between the lid member 207 and the liquid absorber 299 around the step portion 227. This space A2 communicates with the air chamber 224. Therefore, even if air expands at the top portion of the liquid absorber 299, the air can escape from the air communication passage 40 to the outside through the notches 229, the space A2 and the air chamber 224. With this configuration, pressure inside the liquid storage chamber 200 can be prevented from increasing and ink can be prevented from leaking out from the liquid supply portion 280 side.

As illustrated in FIGS. 15 and 16, a protruding wall 46 is formed on a lower surface of the lid member 207 that forms the top surface 202 of the housing 21. The protruding wall 46 is positioned on the lid member 207 between the step portion 227 and the connection port 41 and the tube 42. The protruding wall 46 is also positioned in the liquid storage chamber 200 between the absorber chamber 223 and the connection port 41 and the tube 42. The width of the protruding wall 46 along the X-direction is approximately the same as the width of the top portion of the liquid storage chamber 200. In this embodiment, as illustrated in FIG. 17, a top corner portion of the liquid absorber 299 makes contact with the protruding wall 46.

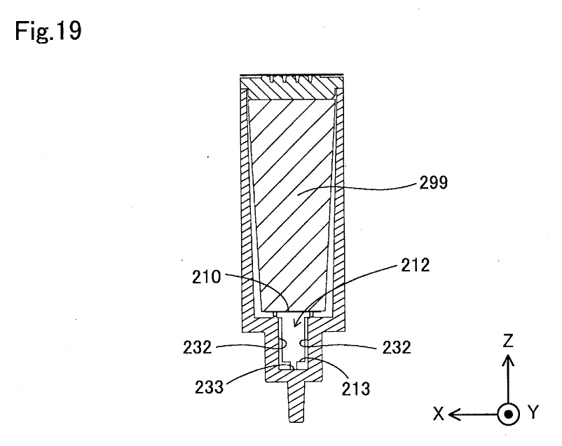

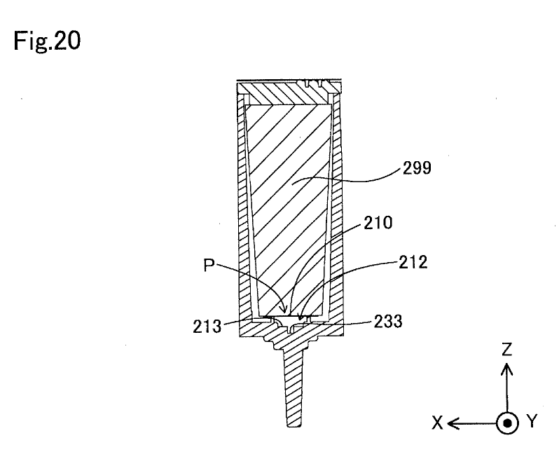

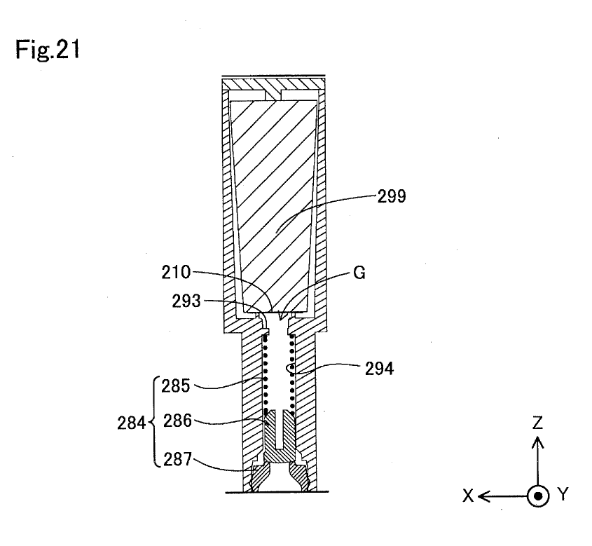

FIG. 18 is a perspective view for illustrating the structure of the bubble trapping chamber 212. FIG. 19 is a cross-sectional view taken along the line XIX-XIX in FIG. 18. FIG. 20 is a cross-sectional view taken along the line XX-XX in FIG. 18. FIG. 21 is a XZ cross-sectional view of the vicinity of the liquid supply portion 280. Note that FIGS. 18 to 21 illustrate a bubble trapping chamber 212 that corresponds to one liquid storage chamber 200 among three liquid storage chambers 200.

FIG. 18 illustrates a state in which the bubble trapping chamber 212 is viewed from the opening 215 formed in the bottom portion 214 of the liquid storage chamber 200. In this embodiment, the bubble trapping chamber 212 has a liquid guiding passage 231 for guiding liquid to the liquid supply portion 280. Even if there are bubbles in the bubble trapping chamber 212, ink can smoothly flow to the liquid supply portion 280 in the bubble trapping chamber 212 by flowing through the liquid guiding passage 231.

In this embodiment, a plurality of liquid guiding passages 231 are provided in the bubble trapping chamber 212. The plurality of liquid guiding passages 231 includes a first liquid guiding passage 232 and a second liquid guiding passage 233. As illustrated in FIGS. 18 and 19, the first liquid guiding passage 232 is formed on a side surface of the bubble trapping chamber 212 so as to extend from top to bottom. In this embodiment, first liquid guiding passages 232 are formed on a positive X-direction side surface and a negative X-direction side surface among the plurality of side surfaces of the bubble trapping chamber 212. As illustrated in FIGS. 18 and 20, the second liquid guiding passage 233 is formed on the bottom surface 213 of the bubble trapping chamber 212 so as to extend toward the liquid supply portion 280 in the Y-direction which is the longitudinal direction of the bubble trapping chamber 212. In this embodiment, each liquid guiding passage 231 is formed of a groove. As illustrated in FIG. 8, the second liquid guiding passage 233 is deeper from the bottom surface 213 closer to the liquid supply portion 280 such that the flow passage cross-sectional area of the second liquid guiding passage 233 is larger closer to the liquid supply portion 280. Note that the liquid guiding passages 231 are not limited to a groove and may be formed of ribs. If the liquid guiding passages 231 are formed of ribs, for example, a pair of ribs is provided on the bottom surface 213 or the side surface of the bubble trapping chamber 212 and ink flows between the pair of ribs.

As illustrated in FIGS. 8 and 18, the bottom surface 213 of the bubble trapping chamber 212 is inclined so as to reduce in height toward the liquid supply portion 280. In this embodiment, as illustrated in FIGS. 8 and 20, the distance between at least one portion of the outer peripheral portion of the filter 210 and the bottom surface 213 of the bubble trapping chamber 212 is shorter than the distance between other portions of the filter 210 and the bottom surface 213. In this embodiment, the distance between an outer peripheral portion P of the filter 210 on a side of the filter 210 far from the liquid supply portion 280 in the longitudinal direction and the bottom surface 213 of the bubble trapping chamber 212 is shorter than the distance between another portion of the filter 210 and the bottom surface 213 of the bubble trapping chamber 212. The other portion of the filter 210 is a portion other than the outer peripheral portion P of the filter 210 and, for example, is a central portion of the filter 210 in the longitudinal direction or a portion that opposes the liquid supply portion 280 in the Z-direction. In this embodiment, by forming the bubble trapping chamber 212 such that an angle of inclination of the bottom surface 213 in the horizontal direction gradually decreases closer to the outer peripheral portion P of the filter 210 from the liquid supply portion 280, the distance between the outer peripheral portion P of the filter 210 and the bottom surface 213 is made shorter than the distance between the other portion of the filter 210 and the bottom surface 213.

As illustrated in FIG. 18, in this embodiment, circular holes are formed above the valve chamber 294 of the liquid supply portion 280 and slit-shaped holes that extend in the up/down direction are formed to the side of the valve chamber 294. With these holes, space inside the valve chamber 294 communicates with the bubble trapping chamber 212 on the top and the side. Further, in this embodiment, the bubble trapping chamber 212 is divided into two spaces A3 and A4 in the Y-direction by the valve chamber 294. However, as illustrated in FIGS. 18 and 21, the spaces A3 and A4 communicate with each other via a gap G between the top surface 293 of the valve chamber 294 and the filter 210.

### A3. Effects of First Embodiment

(1-1) According to the above-described embodiment, as illustrated in FIGS. 8 and 10, a relatively large filter 210 is disposed between the liquid storage chamber 200 and the bubble trapping chamber 212 of the cartridge 20. Therefore, when the cartridge 20 is used, ink can easily flow from the liquid storage chamber 200 to the bubble trapping chamber 212 and the liquid supply portion 280. As a result, ink can be prevented from accumulating at a portion of the liquid absorber 299 far from the liquid supply portion 280.

(1-2) In the first embodiment, because the bottom surface portion 298 of the liquid absorber 299 illustrated in FIG. 17 is compressed more than the central portion 297 of the liquid absorber 299 in the height direction, the capillary strength of the bottom surface portion 298 of the liquid absorber 299 can be increased. With this configuration, under a state where the cartridge 20 is filled with ink, an ink layer is formed in the bottom surface portion 298 of the liquid absorber 299. As a result, when the cartridge 20 is subject to impact such as the cartridge 20 being dropped, the ink layer can prevent bubbles from flowing from the liquid absorber 299 side to the bubble trapping chamber 212. Therefore, even when the filter 210 is large as in the first embodiment, can be effectively prevented from flowing from the liquid absorber 299 side to the bubble trapping chamber 212. In addition, because bubbles can be prevented from flowing from the liquid absorber 299 side to the bubble trapping chamber 212 side, ink can be prevented from flowing back from the bubble trapping chamber 212 side to the liquid absorber 299 side due to bubbles entering the bubble trapping chamber 212. As a result, ink can be prevented from flowing out from the liquid storage chamber 200 via the air communication passage 40.

(1-3) In the first embodiment, because the cross-sectional area of the internal space of the liquid storage chamber 200 along the horizontal direction is smaller on the bottom portion 214 side of the liquid storage chamber 200 than the top portion side of the liquid storage chamber 200, the cuboid liquid absorber 299 can be compressed toward the bottom portion 214 of the liquid storage chamber 200. Therefore, the capillary strength of the liquid absorber 299 can be increased toward the bottom portion 214 and ink can be made to flow smoothly from the top portion side to the bottom portion 214 side in the liquid absorber 299.

(1-4) In the first embodiment, as illustrated in FIG. 9, the convex portion 216 that extends along the up/down direction is formed on the side wall 24 of the liquid storage chamber 200 and the convex portion 216 includes a part inclined so as to protrude further closer to the bottom portion 214 from the top portion of the liquid storage chamber 200. Therefore, the liquid absorber 299 can be compressed toward the bottom portion 214 side of the liquid storage chamber 200, and hence the capillary strength of the liquid absorber 299 can be increased toward the bottom portion 214 side. As a result, ink can be made to flow smoothly from the top portion side to the bottom portion 214 side in the liquid absorber 299. In addition, by forming the concave portion 216 on the side wall 24, a space is formed between the side surface of the liquid absorber 299 and the side wall 24. Therefore, if air inside the liquid absorber 299 expands due to an increase in external temperature or some other reason, the ink inside the liquid absorber 299 seeps out to the space between the liquid absorber 299 and the side wall 24. As a result, the liquid surface of ink inside the liquid storage chamber 200 can be prevented from increasing and the ink can be prevented from leaking outside the cartridge 20 due to expansion of the air inside the liquid absorber 299. In addition, the ink that has seeped into the space between the liquid absorber 299 and the side wall 24 can be prevented from being reabsorbed by the liquid absorber 299, and hence liquid can be prevented from accumulating in the cartridge 10.

(1-5) In the first embodiment, in the liquid storage chamber 200, the first convex portions 217 and the second convex portions 218 that are taller than the first convex portions are alternately arranged on the side wall 24 with intervals therebetween. Because of this, spaces formed due to the convex portions 216 and the liquid absorber 299 making contact cab be made to communicate with each other above the first convex portion 217 and ink that has seeped out from the liquid absorber 299 can be prevented from existing on only one side in the liquid storage chamber 200. As a result, ink can be effectively prevented from leaking to the outside of the cartridge 10. In addition, in the first embodiment, because the space communicates until the air chamber 224, liquid that has seeped out from the liquid absorber 299 can flow until the air chamber that has a relatively large capacity and is prevented from leaking to the outside. In addition, if air is expelled from the liquid absorber 299 to the above-mentioned space, the air is expelled to the outside via the air chamber 224 and the air communication passage 40. As a result, ink can be effectively prevented from leaking from the liquid supply portion 280 side due to expanded air.

(1-6) In the first embodiment, as illustrated in FIG. 11, because the surface 217s of the first convex portion 217 that faces the liquid storage chamber 200 side and the surface 218s of the second convex portion 218 that faces the liquid storage chamber 200 side at a portion higher than the first convex portion 217 are on the same virtual plane VP, the side surface of the liquid absorber 299 can be favorably compressed due to the first convex portion 217 and the second convex portion 218. Therefore, the capillary strength of the liquid absorber 299 can be gradually increased from the top portion to the bottom portion and the ink can be made to smoothly flow toward the bottom portion.

(1-7) In the first embodiment, the positioning protrusion 219 for positioning the filter 210 is formed on the bottom portion 214 of the liquid storage chamber 200. Therefore, the filter 210 can be easily fixed to the bottom portion 214 of the liquid storage chamber 200.

(2-1) According to the first embodiment, the capillary strength of the bottom surface portion 298 of the liquid absorber 299 is greater than the capillary strength of the central portion 297 of the liquid absorber 299 in the height direction, and hence ink is favorably maintained around the filter 210 of the liquid absorber 299. As a result, even if the filter 210 has a large area, air on the liquid absorber 299 side is less likely to enter the bubble trapping chamber 212 side and the liquid supply portion 280 side when the cartridge 20 is subject to impact such as being dropped. Therefore, the occurrence of ink discharge failure or ink supply failure can be minimized.

(2-2) Further, in the first embodiment, the capillary strength of the filter 210 disposed below the liquid absorber 299 is greater than the capillary strength of the liquid absorber 299, and hence ink is more likely to be held in the filter 210. As a result, air inside the liquid absorber 299 is further less likely to enter the bubble trapping chamber 212 side. In addition, because ink can be accumulated in the filter 210, ink can be prevented from staying in the liquid absorber 299. Note that in other embodiments, the capillary strength of the filter 210 may be less than the capillary strength of the bottom surface portion 298 of the liquid absorber 299.

(2-3) In the first embodiment, the step portion 227 that protrudes downward is formed on the ceiling surface 226 of the liquid storage chamber 200. Therefore, the capillary strength of the bottom surface portion 298 of the liquid absorber 299 can be easily increased.

(2-4) In the first embodiment, the maximum width W1 illustrated in FIG. 15 of the step portion 227 along the transverse direction of the filter 210 is larger than the maximum width W2 illustrated in FIG. 10 along the transverse direction of the filter 210. Therefore, the capillary strength of the bottom surface portion 298 of the liquid absorber 299 can be favorably increased.

(3-1) In the first embodiment, the absorber chamber 223 provided with the liquid absorber 299 and the air chamber 224 not provided with the liquid absorber 299 are arranged in a row in the horizontal direction in the liquid storage chamber 200 and the side surface of the liquid absorber 299 makes contact with air inside the air chamber 224. Therefore, ink that has leaked out from the liquid absorber 299 due to a temperature change, a change in internal pressure, or a change in the posture of the cartridge 10 enters the air chamber 224 adjacent to the liquid absorber 299 and the ink that has entered the air chamber 224 is reabsorbed by the liquid absorber 299. Further, in this embodiment, the connection port 41 that connects the air chamber 224 and the air communication passage 40 to each other is provided on a top portion of the air chamber 224, and hence the possibility of ink that has leaked out from the liquid absorber 299 to the air chamber 224 leaking to the outside of the cartridge 10 can be reduced. Therefore, according to the cartridge 20 of this embodiment, ink is less likely to leak out and can be efficiently provided to the liquid jetting apparatus 50.

(3-2) In the first embodiment, because the connection port 41 that communicates with air is provided on a tip of the tube 42 that protrudes downward from the ceiling surface 226 of the air chamber 224, even if the posture of the cartridge 10 is deformed in a state where the air chamber 224 contains ink, the ink is less likely to enter the air communication passage 40. Therefore, the ink can be prevented from leaking to the outside.

(3-3) In the first embodiment, the air communication port 44 which is the port for connecting the air communication passage 40 and air is provided on the bottom surface 201 of the housing 21 and the air communication passage 40 extends from the top surface 202 side to the bottom surface 201 side of the housing 21. Therefore, even if the cartridge 20 is turned upside-down, ink is less likely to flow to the outside of the cartridge 10 because the air communication port 44 faces upward.

(3-4) In the first embodiment, the winding flow passages 43 as part of the air communication passage 40 have capillary strength to deal with ink, and hence, even if the ink enters the winding flow passages 43, the ink is less likely to flow to the outside. In addition, even if the ink does enter the winding flow passages 43, air flows into the winding flow passages 43 from the air communication passage 40 as the ink inside the liquid storage chamber 200 is consumed, and hence the ink inside the winding flow passages 43 can flow back to the liquid storage chamber 200 via the air chamber 224.

(3-5) In the first embodiment, the protruding wall 46 that protrudes downward is provided on the top surface 202 of the housing 21 between the absorber chamber 223 and the connection port 41. Therefore, even if the cartridge 20 is turned upside-down, ink can be prevented from flowing from the absorber chamber 223 side to the connection port 41 side. In addition, because the protruding wall 46 is provided between the absorber chamber 223 and the connection port 41, the liquid absorber 299 can be prevented from traveling past the protruding wall 46 to the air chamber 224 side. In the first embodiment, because the liquid absorber 299 makes contact with the protruding wall 46, even if the cartridge 20 is turned upside-down, ink that has accumulated around the lid member 207 can be sent back to the liquid absorber 299 from the contact portion between the liquid absorber 299 and the protruding wall 46.

(4-1) According to the first embodiment, because the bubble trapping chamber 212 is provided with the liquid guiding passage 231 for guiding the ink to the liquid supply portion 280, the ink inside the bubble trapping chamber 212 is more likely to flow to the liquid supply portion 280 via the liquid guiding portion 231. Therefore, even if there are bubbles in the bubble trapping chamber 212, the occurrence of the flow of ink being impeded by the bubbles can be minimized. As a result, the occurrence of ink discharge failure can be minimized.

(4-2) In the first embodiment, the bubble trapping chamber 212 is provided with the plurality of liquid guiding passages 231. Therefore, ink inside the bubble trapping chamber 212 can more favorably travel to the liquid supply portion 280.

(4-3) In the first embodiment, the plurality of liquid guiding passages 231 includes a first liquid guiding passage 232 formed so as to extend from top to bottom on the side surface of the bubble trapping chamber 212. Therefore, ink can favorably travel from the liquid storage chamber 200 to the bubble trapping chamber 212.

(4-4) In the first embodiment, plurality of liquid guiding passages 231 includes a second liquid guiding passage 233 formed so as to extend toward the liquid supply portion 280 in the longitudinal direction of the bubble trapping chamber 212. Therefore, ink inside the bubble trapping chamber 212 can favorably flow to the liquid supply portion 280.

(4-5) In the first embodiment, the second liquid guiding passage 233 is formed of a groove and has a larger flow passage cross-sectional area closer to the liquid supply portion 280. Therefore, flow passage resistance of the second liquid guiding passage 233 can be reduced and ink can favorably flow to the liquid supply portion 280.

(4-6) In the first embodiment, the bottom surface 213 of the bubble trapping chamber 212 is inclined so as to reduce in height toward the liquid supply portion 280. Therefore, ink inside the bubble trapping chamber 212 can favorably flow to the liquid supply portion 280.

(4-7) In the first embodiment, the liquid guiding passages 231 can be formed of grooves or ribs. Therefore, the liquid guiding passages 231 can be formed with a simple structure.

(4-8) In the first embodiment, the distance between at least one portion on the outer peripheral portion of the filter 210 and the bottom surface 213 of the bubble trapping chamber 212 is closer than the distance between another portion of the filter 210 and the bottom surface 213. Therefore, at this close portion, bubbles are less likely to enter from other portions of the bubble trapping chamber 212. As a result, ink inside the bubble trapping chamber 212 can favorably flow from the filter 210 at the close portion.

(4-9) In the first embodiment, the inside of the valve chamber 294 that forms the liquid supply portion 280 communicates with the top and side of the bubble trapping chamber 212. Therefore, bubbles inside the valve chamber 294 can also enter the bubble trapping chamber 212. As a result, the possibility of bubbles being expelled from the liquid supply portion 280 can be reduced.

(4-10) In the first embodiment, the bubble trapping chamber 212 is divided into the plurality of spaces A3 and A4 by the valve chamber 294 and the spaces A3 and A4 communicate with each other due to the gap G formed between the top surface 293 of the valve chamber 294 and the filter 210. Therefore, the space inside the bubble trapping chamber 212 in which bubbles can exist increases. As a result, the possibility of bubbles being expelled from the liquid supply portion 280 can be reduced.

(5-1) According to the first embodiment, ink can concentrate at the filter 210 disposed on the bottom surface portion 298 of the liquid absorber 299 or below the liquid absorber 299, and hence ink can smoothly be supplied from the liquid storage chamber 200 side to the bubble trapping chamber 212 provided below the liquid storage chamber 200. In addition, because the bubble trapping chamber 212 includes the liquid guiding passages 231, ink can smoothly flow within the bubble trapping chamber 212 even if bubbles exist in the bubble trapping chamber 212. Therefore, there can be provided a cartridge 20 that can be applied to a liquid jetting apparatus that rapidly ejects ink.

(5-2) The cartridge 20 according to the first embodiment includes the valve mechanism 284 formed of the valve element 286 and the biasing member 285 because the liquid supply portion 280 can receive the liquid supply needle 640. Therefore, in a state before the cartridge 20 is used, ink inside the liquid storage chamber 200 is effectively prevented from leaking out from the liquid supply portion 280 by both the film FM and the valve mechanism 284.

### B. Second Embodiment

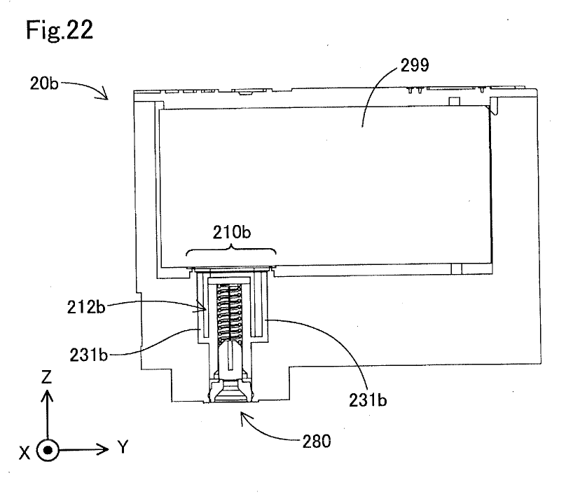

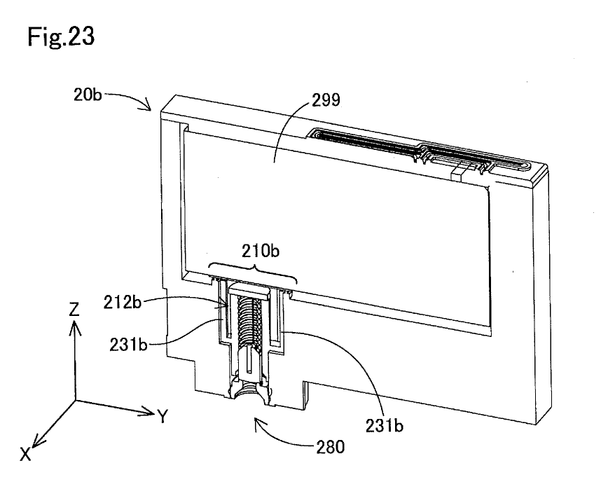

FIG. 22 is a cross-sectional view for illustrating a cartridge 20b according to a second embodiment. FIG. 23 is a perspective view of the cartridge 20b illustrated in FIG. 22. In the above-described first embodiment, the length of the filter 210 provided in the cartridge 20 is 50% or more the length of the liquid absorber 299 along the Y-direction. In contrast, in the second embodiment, a filter 210b is 50% smaller than the length of the liquid absorber 299. In addition, the bubble trapping chamber 212b has a substantially cuboid shape and the liquid guiding passage 231b is formed so as to extend in a perpendicular direction on an inner surface of the bubble trapping chamber 212b in the positive Y-direction and the negative Y-direction. Even in the second embodiment, ink inside the bubble trapping chamber 212b can smoothly flow to the liquid supply portion 280.

### C. Third Embodiment

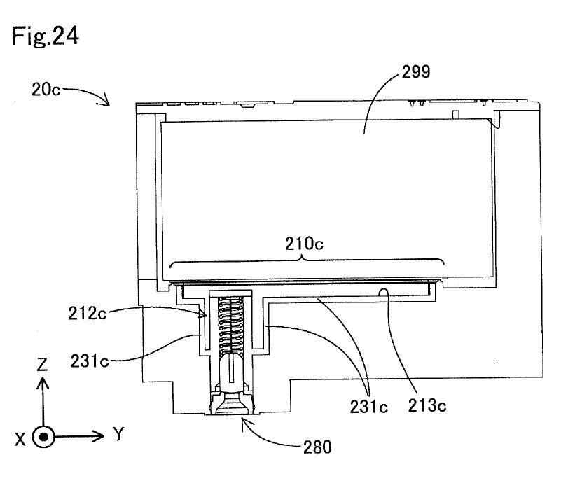

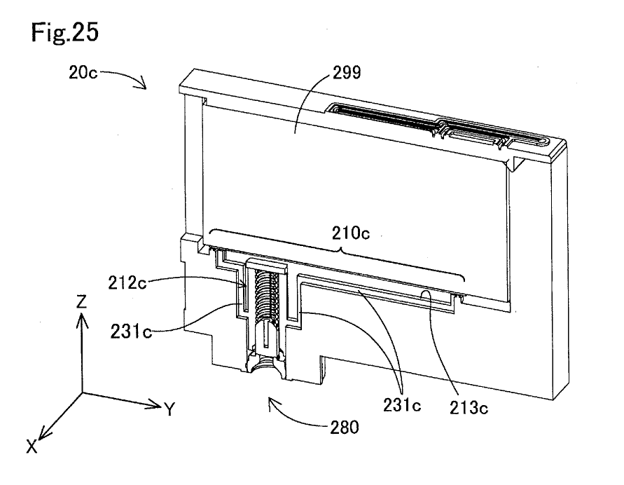

FIG. 24 is a cross-sectional view for illustrating a cartridge 20c according to a third embodiment. FIG. 25 is a perspective view of the cartridge 20c illustrated in FIG. 24. In the above-described second embodiment, the length of the filter 210b is 50% smaller than the length of the liquid absorber 299 along the Y-direction. In contrast, in the third embodiment, the length of a filter 210c is 50% or more the length of the liquid absorber 299, which is similar to the first embodiment. However, the third embodiment differs from the first embodiment in that a bottom surface 213c of a bubble trapping chamber 212c is not inclined toward the liquid supply portion 280 but horizontal and is perpendicularly depressed around the liquid supply portion 280. Further, in the third embodiment, a liquid guiding passage 231c is formed horizontally along the bottom surface 213c of the bubble trapping chamber 212c and is perpendicularly depressed around the bubble trapping chamber 212c. Even in the third embodiment, ink inside the bubble trapping chamber 212c can flow smoothly to the liquid supply portion 280.

### D. Fourth Embodiment

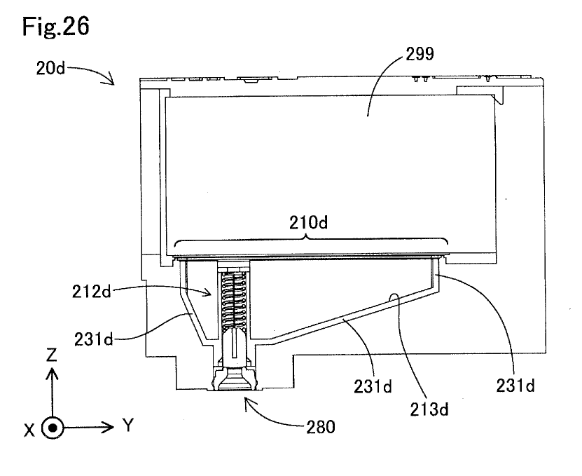

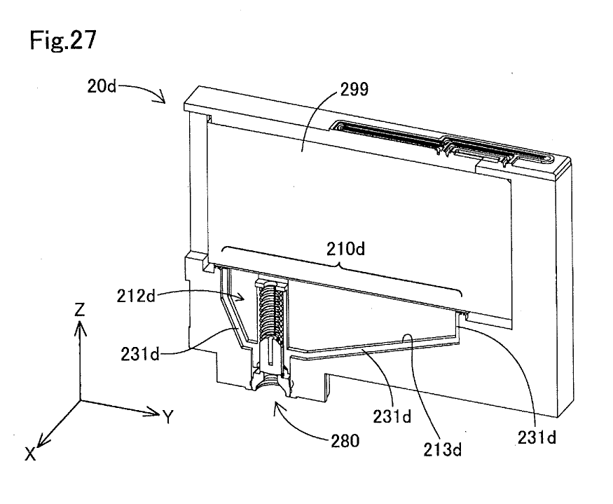

FIG. 26 is a cross-sectional view for illustrating a cartridge 20d according to a fourth embodiment. FIG. 27 is a perspective view of the cartridge 20d illustrated in FIG. 26. In this embodiment, similar to the first embodiment, a bottom surface 213d of a bubble trapping chamber 212d is inclined so as to reduce in height toward the liquid supply portion 280. However, the fourth embodiment differs from the first embodiment in that the bottom surface 213d of the bubble trapping chamber 212d does not closely contact a filter 210d on an outer peripheral portion of the filter 210d in the longitudinal direction and is perpendicularly depressed around both ends of the filter 210d in the longitudinal direction. A liquid guiding passage 231d is formed at a central portion of the inner wall of the perpendicularly depressed portion. The liquid guiding passage 231d is formed so as to be continuous with the inclined bottom surface 213d and reaches the liquid supply portion 280. Even in the fourth embodiment, ink inside the bubble trapping chamber 212d can smoothly flow to the liquid supply portion 280.

### E. Fifth Embodiment

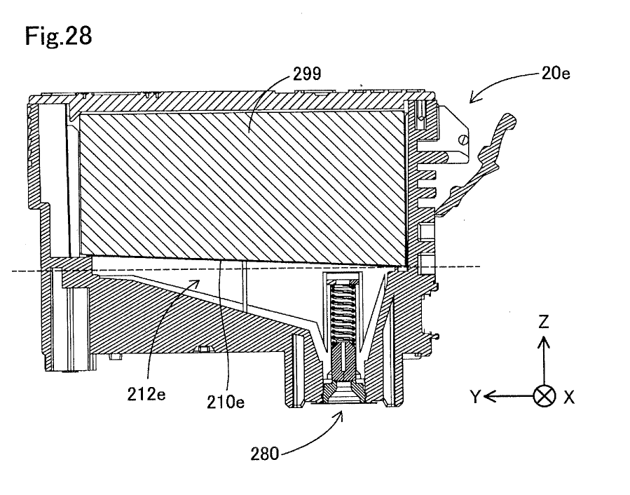

FIG. 28 is a cross-sectional view for illustrating a cartridge 20e according to a fifth embodiment. In this embodiment, in a mounting state of the cartridge 20e, a filter 210e is inclined in the horizontal direction (Y-direction) indicated by the broken line. With this kind of configuration, bubbles in the bubble trapping chamber 212e travel upward along the inclined filter 210e, and hence the possibility of the bubbles being discharged from the liquid supply portion 280 can be reduced. In this embodiment, the filter 210e is inclined such that one terminal position of the filter 210e on a side far from the liquid supply portion 280 is taller than another terminal position of the filter 210e. Therefore, the distance between a position at which bubbles accumulate and the liquid supply portion 280 can be made wider and the possibility of bubbles being expelled from the liquid supply portion 280 can be reduced further.

### F. Sixth Embodiment

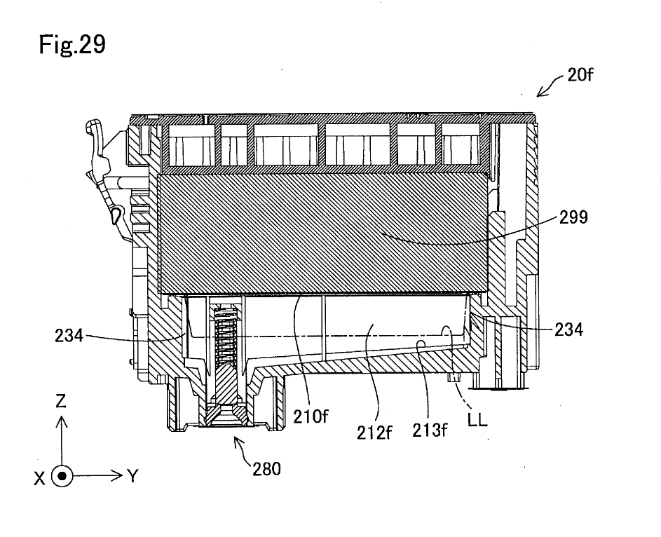

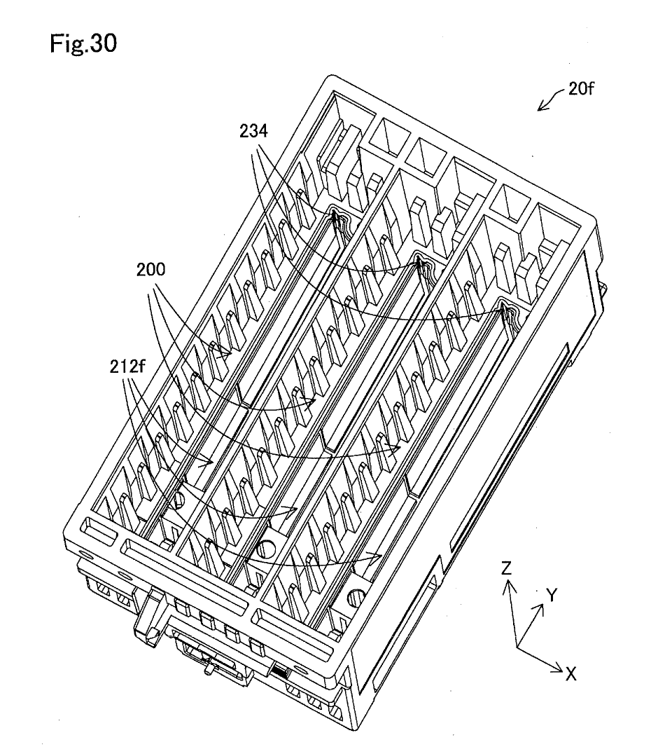

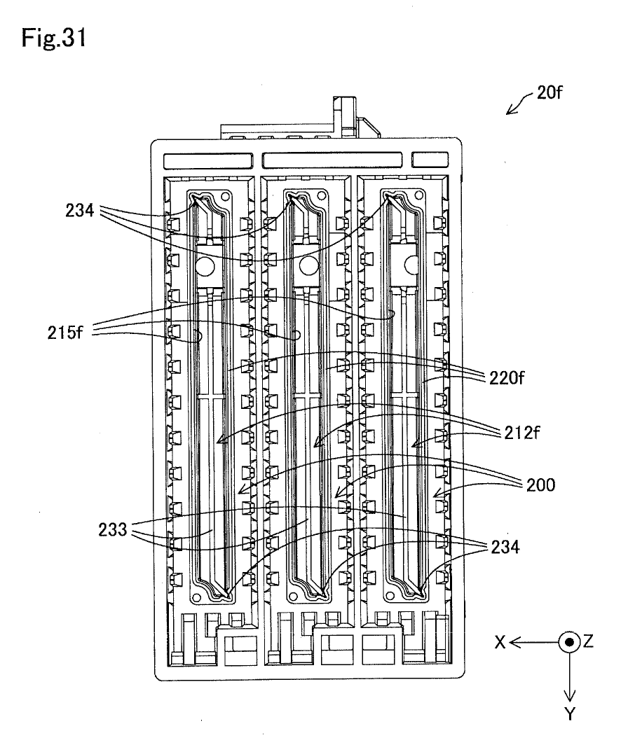

FIG. 29 is a cross-sectional view for illustrating a cartridge 20f according to a sixth embodiment. FIG. 30 is a perspective view for illustrating the liquid storage chamber 200 of the cartridge 20f from a top surface side. FIG. 31 is a plan view for illustrating the liquid storage chamber 200 of the cartridge 20f from a top surface. The lid member 207, the liquid absorber 299 and a filter 210f are omitted from FIGS. 30 and 31.

As illustrated in FIG. 29, in this embodiment, similar to the first embodiment, a bottom surface 213f of the bubble trapping chamber 212f is inclined so as to reduce in height toward the liquid supply portion 280. Similar to the cartridge 20d according to the fourth embodiment illustrated in FIGS. 26 and 27, the bottom surface 213f of the bubble trapping chamber 212f is perpendicularly depressed around both ends of the filter 210f in the longitudinal direction. As illustrated in FIGS. 29 to 31, the bubble trapping chamber 212f according to this embodiment includes a groove portion 234 that connects the filter 210f and the bottom surface 213f of the bubble trapping chamber 212f to each other.

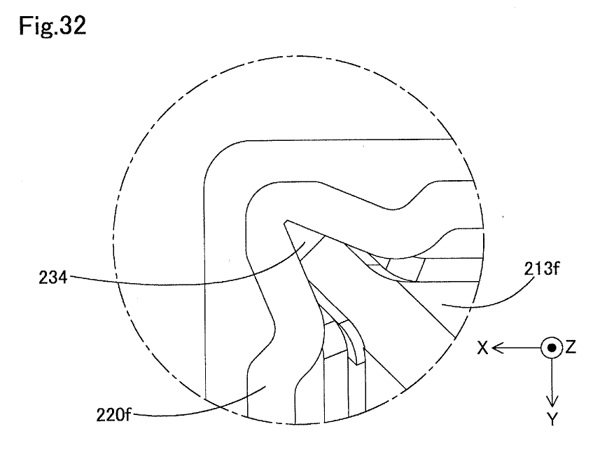

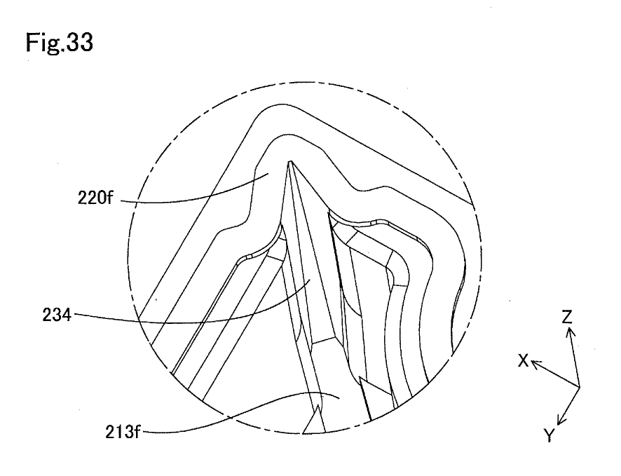

FIG. 32 is an enlarged view for illustrating the groove portion 234 as seen from the top surface side. FIG. 33 is a perspective view of the groove portion 234 as seen from the top surface side. The groove portion 234 is disposed in the bubble trapping chamber 212f along the Z-direction which is a perpendicular direction. The groove portion 234 according to this embodiment is provided on a corner portion of the bubble trapping chamber 212f. The corner portion of the bubble trapping chamber 212f is a portion on each of multiple internal side surfaces that form the bubble trapping chamber 212f which intersects with an adjacent internal side surface. In this embodiment, as illustrated in FIG. 31, groove portions 234 are formed at the following two corner portions of the bubble trapping chamber 212f: a corner portion at which an internal side surface on the positive X-direction side and an internal side surface on the negative Y-direction side intersect, and a corner portion at which an internal side surface on the negative X-direction side and an internal side surface on the positive Y-direction side intersect. As illustrated in FIG. 31, the groove portion 234 according to this embodiment is connected to the second liquid guiding passage 233 formed on the bottom surface 213f of the bubble trapping chamber 212f. Similar to the first embodiment, the second liquid guiding passage 233 is formed of a groove and is formed to have a larger flow passage cross-sectional area closer to the liquid supply portion 280.

The groove portion 234 has capillary strength. In other words, the flow passage cross-sectional area and length of the groove portion 234 are set such that the groove portion 234 has capillary against the ink inside the bubble trapping chamber 212f. In this embodiment, as illustrated in FIG. 33, an interval between the thinnest grooves in the groove portion 234 is narrower at a position closer to the filter 210f, that is, closer to the top side. Therefore, the groove portion 234 has greater capillary strength closer to the filter 210f. In this embodiment, the groove portion 234 is configured such that the height at which ink is sucked up is higher than a height of a portion in the Z-direction formed with the groove portion 234 of the bubble trapping chamber 212f. The groove portion 234 is configured such that the height at which ink is sucked up is higher than the portion formed with the groove portion 234 of the bubble trapping chamber 212f when the ink inside the bubble trapping chamber 212 is sucked up to the filter 210f along the groove portion 234.

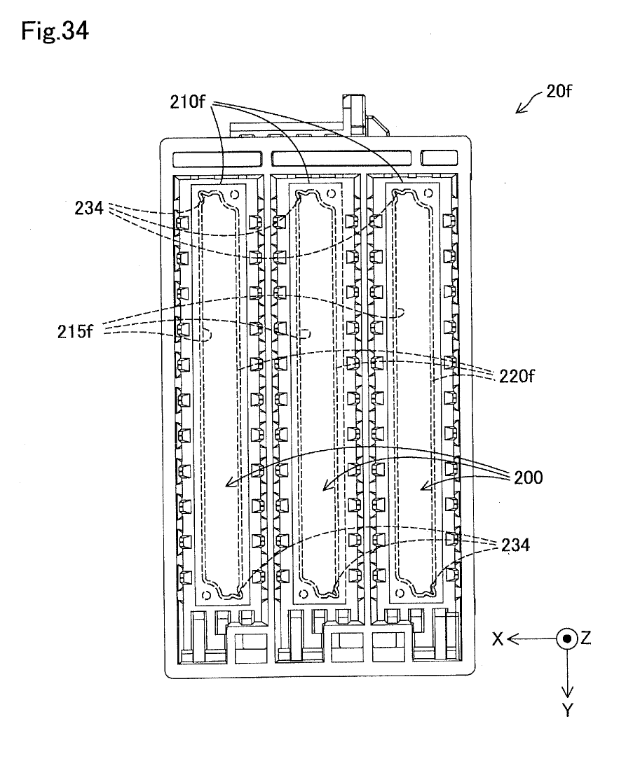

FIG. 34 is a plan view for illustrating the liquid storage chamber 200 of the cartridge 20f from a top surface side. In FIG. 34, the lid member 207 and the liquid absorber 299 are omitted. As illustrated in FIG. 34, similar to the first embodiment, large openings 215f are also formed on the bottom portion 214 of the liquid storage chamber 200 in this embodiment and the filters 210f are disposed so as to cover the openings 215f. In FIG. 34, the portions of the filters 210f indicated by broken lines represent welded portions 220f at which the filters 210f are welded. The welded portions 220f are convex portions formed along the outer periphery of the openings 215f. Corner portions of the welded portions 220f and the openings 215f that correspond to portions at which the groove portions 234 narrow according to the shape of the groove portion 234.

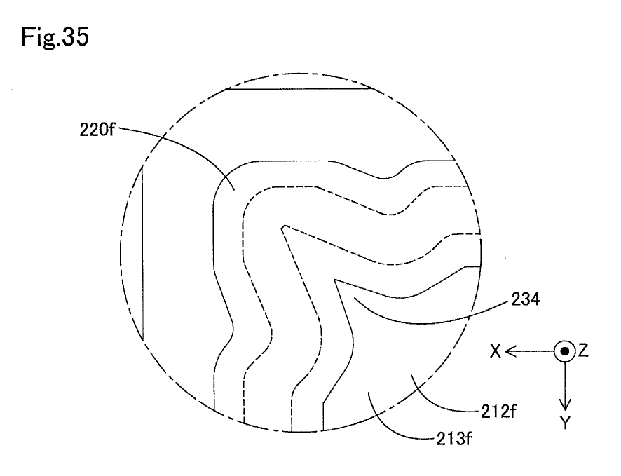

FIG. 35 is an enlarged view for illustrating the welded portion 220f. The shape indicated by the broken line in FIG. 35 represents the shape of the welded portion 220f before the filter 210f is welded thereto. In contrast, the shape indicated by the solid lines represents the shape of the welded portion 220 after the filter 210f has been welded thereto. When the filter 210f is welded to the welded portion 220f, the material that forms the welded portion 220f melts at the portion of the welded portion 220f that makes contact with the filter 210f and the welded portion 220f becomes thicker as illustrated in FIG. 35. However, even if the material melts due to being welded, as illustrated in FIG. 35, a groove shape remains in the corner portion of the bubble trapping chamber 212f and the groove portion 234 is still formed. Therefore, even if the welded portion 220f becomes thicker due to the filter 210f being welded on the welded portion 220f, the groove portion 234 still connects the filter 210f and the bottom surface 213f of the bubble trapping chamber 212f to each other. In other words, even if the welded portion 220f becomes thicker due to the filter 210f being welded on the welded portion 220f, both ends of the groove portion 234 make contact with the filter 210f and the bottom surface 213f of the bubble trapping chamber 212f.

According to the above-described sixth embodiment, the bubble trapping chamber 212f includes the groove portion 234 that connects the filter 210f and the bottom surface 213f of the bubble trapping chamber 212f to each other, and hence ink inside the bubble trapping chamber 212f can easily flow to the liquid supply portion 280 through the groove portion 234. Therefore, even if the bubble trapping chamber 212f contains bubbles, the bubbles can be prevented from impeding the flow of ink. In addition, according to the sixth embodiment, ink inside the bubble trapping chamber 212f can be easily sucked up to the filter 210f side through the groove portion 234 when, for example, air has expanded in the bubble trapping chamber 212f. Therefore, ink can be prevented from being pushed out and leaking from the liquid supply portion 280 due to the expansion of air inside the bubble trapping chamber 212. Therefore, according to the cartridge 20f of this embodiment, the occurrence of ink discharge failure and ink supply failure can be minimized. In FIG. 29, a liquid surface LL of the ink when the ink is sucked up from the groove portion 234 as a result of air inside the bubble trapping chamber 212f expanding is indicated by the alternate long and short dashed line.

In the sixth embodiment, the groove portion 234 can easily hold ink because the groove portion 234 has capillary strength. Therefore, ink can be reliably prevented from leaking out due to air inside the bubble trapping chamber 212f expanding.

In the sixth embodiment, the bubble trapping chamber 212f include the groove portion 234 at corner portions of the bubble trapping chamber 212f. Therefore, the corner portions of the bubble trapping chamber 212 can be used to efficiently form the groove portion 234.

In the sixth embodiment, the groove portion 234 is narrower at a position closer to the filter 210f. Therefore, the capillary strength of the groove portion 234 can be increased closer to the filter 210f, and hence ink inside the bubble trapping chamber 212 can be efficiently sucked up to the filter 210f side when, for example, air inside the bubble trapping chamber 212 has expanded.

In the sixth embodiment, the groove portion 234 is configured such that the height at which ink is sucked up is higher than the portion formed with the groove portion 234 of the bubble trapping chamber 212f. Therefore, the ink inside the bubble trapping chamber 212 can be more reliably sucked up to the filter 210f side when, for example, air inside the bubble trapping chamber 212 has expanded.

In the sixth embodiment, the bubble trapping chamber 212f includes a plurality of the groove portions 234. Therefore, the occurrence of ink discharge failure and ink supply failure can be more reliably minimized compared to a case where the bubble trapping chamber 212f only includes one groove portion 234.

Note that, in the sixth embodiment, the groove portions 234 are formed at two corner portions of the bubble trapping chamber 212f, but the groove portions 234 may be formed at all corner portions of the bubble trapping chamber 212f or only one groove portion 234 may be formed at one corner portion. Further, the groove portion 234 is not limited to being formed at a corner portion of the bubble trapping chamber 212f and may be formed at any place on the inner side surface of the bubble trapping chamber 212f. In other words, the first liquid guiding passage 232 according to the first embodiment may be configured as the groove portion 234 according to this embodiment.

In the sixth embodiment, the groove portion 234 has capillary strength and is narrower at a position closer to the filter 210f. Further, in the sixth embodiment, the groove portion 234 is configured such that the height at which ink is sucked up is higher than the portion formed with the groove portion 234 of the bubble trapping chamber 212f. However, these requirements need not always be applied and the groove portion 234 may be configured in any way provided that the groove portion 234 connects the filter 210f and the bottom surface 213f of the bubble trapping chamber 212f to each other.

### G. Other Embodiments

(G1) In the above-described embodiments, the filter 210 is smaller than the bottom portion 214 of the liquid storage chamber 200. In contrast, the entire bottom portion of the liquid storage chamber 200 or the entire top surface of the bubble trapping chamber 212 may be formed of the filter 210.

(G2) The cartridge 20 is not limited to the above-described embodiments and may have numerous other configurations. For example, the cartridge 20 may be configured in any way provided that the cartridge 20 includes at least the liquid storage chamber 200 and the liquid supply portion 280. All or some of the following components may be omitted as necessary provided that the cartridge 20 can achieve at least some of the effects of the above-described embodiments: the filter 210, the bubble trapping chamber 212, the liquid absorber 299, the absorber chamber 223, the air chamber 224, the connection port 41, the tube 42, the air communication passage 40, the air communication port 44, the winding flow passages 43, the concave portion 45, the convex portion 216, the protruding wall 46, the step portion 227, the liquid guiding passage 231, the valve element 286, the biasing member 285, the valve chamber 294 and the positioning protrusion 219.

(G3) The disclosure is not limited to a printer and an ink cartridge for a printer and can also be applied to any type of liquid jetting apparatus that uses a liquid other than ink and a cartridge used in such a liquid jetting apparatus. For example, the disclosure can be applied to a cartridge used in the following types of liquid jetting apparatus.

(1) image recording device, such as a facsimile machine;

(2) color material jetting device used to manufacture color filters for an image display device, e.g., a liquid crystal display;

(3) electrode material jetting device used to form electrodes of, for example, an organic EL (electroluminescence) display and a field emission display (FED);

(4) fluid consuming device configured to eject a bioorganic material-containing fluid used for manufacturing biochips;

(5) sample jetting device used as a precision pipette;

(6) jetting device of lubricating oil;

(7) jetting device of a resin solution;

(8) fluid consuming device for pinpoint jetting of lubricating oil on precision machines such as watches or cameras;

(9) fluid consuming device configured to eject a transparent resin solution, such as an ultraviolet curable resin solution, onto a substrate in order to manufacture a hemispherical micro lens (optical lens) used for, for example, optical communication elements;

(10) fluid consuming device configured to eject an acidic or alkaline etching solution in order to etch a substrate or the like; and

(11) fluid consuming device equipped with a fluid jetting head for ejecting a very small volume of droplets of any other fluid.

The “droplet” herein means the state of fluid ejected from the liquid jetting apparatus and may be in a granular shape, a teardrop shape or a tapered threadlike shape. The “fluid” herein may be any material ejectable by the liquid jetting apparatus. The “fluid” may be any material in the liquid phase. For example, liquid-state materials of high viscosity or low viscosity, sols, aqueous gels and other liquid-state materials having inorganic solvents, organic solvents, solutions, liquid resins and liquid metals (metal melts) are included in the “fluid”. The “fluid” is not limited to the liquid state as one of the three states of matter but includes solutions, dispersions and mixtures of the functional solid material particles, such as pigment particles or metal particles, solved in, dispersed in or mixed with a solvent. Typical examples of the fluid include ink described in the above embodiment and liquid crystal. The ink herein includes general water-based inks and oil-based inks, as well as various fluid compositions, such as gel inks and hot-melt inks.

### H. Other Aspects

The disclosure is not limited to the above-described embodiments and can be realized as any type of configuration within the scope that does not depart from the gist of the disclosure. For example, the disclosure can also be implemented in the form of the following aspects. The technical features of the above-described embodiments that correspond to the technical features of the above-described aspects may be replaced or combined as necessary in order to partly or entirely solve the problems to be solved by the disclosure or partly or entirely achieve the effects of the disclosure. Further, any technical aspects not specified in the Specification as required may be omitted as necessary.

(H1-1) According to the first embodiment of the disclosure, there is provided a cartridge which is to be mounted onto a liquid jetting apparatus that includes a liquid supply needle. The cartridge includes a liquid supply portion configured to receive the liquid supply needle; a first chamber provided with a liquid absorber; a second chamber not provided with the liquid absorber and provided with the liquid supply portion; and a filter provided between the first chamber and the second chamber. The length of the filter in a longitudinal direction of the filter is longer than half a length of the liquid absorber in the longitudinal direction.

According to the cartridge of this aspect, liquid is prevented from accumulating at a portion of the liquid absorber far from the liquid supply portion because the cartridge includes a relatively large filter between the first chamber and the second chamber.

(H1-2) In the cartridge according to the above-described aspect, the bottom surface portion of the liquid absorber may be compressed more than a central portion of the liquid absorber in a height direction. By using the cartridge according to this aspect, capillary strength of the bottom surface portion of the liquid absorber can be increased, and hence an ink layer is formed on the bottom surface portion of the liquid absorber. Because of this, bubbles can be prevented from flowing out from the liquid absorber side to the second chamber side.

(H1-3) In the cartridge according to the above-described aspect, a cross-sectional area of an internal space along a horizontal direction of the first chamber may be smaller on a bottom portion side of the first chamber than a top portion side of the first chamber. By using the cartridge according to this aspect, the liquid absorber can be compressed to the bottom portion side of the first chamber, and hence the capillary strength of the liquid absorber can be increased to that of the bottom portion side. Therefore, in the liquid absorber, ink can smoothly flow from the top portion side to the bottom portion side.

(H1-4) In the cartridge according to the above-described aspect, a convex portion that protrudes inward toward the first chamber may be formed on a side wall of the first chamber, the convex portion may extend in an up/down direction and the convex portion may include a part inclined so as to protrude further from a top portion to a bottom portion of the first chamber. By using the cartridge according to this aspect, the liquid absorber can be compressed to the same degree as the bottom portion side of the first chamber, and hence the capillary strength of the liquid absorber can be increased to that of the bottom portion side. Therefore, in the liquid absorber, ink can smoothly flow from the top portion side to the bottom portion side. In addition, by providing the convex portion on the side wall of the first chamber, a space is formed between the liquid absorber and the side wall. As a result, liquid inside the liquid absorber can seep out to that space when, for example, air inside the liquid absorber expands. Therefore, the liquid surface of the liquid inside the liquid storage chamber can be prevented from increasing and the liquid can be prevented from leaking to the outside. In addition, because the liquid that has seeped out to the space is reabsorbed by the liquid absorber, liquid can be prevented from accumulating in the cartridge.

(H1-5) In the cartridge according to the above-described aspect, the convex portion may include a plurality of first convex portions and a plurality of second convex portions that are higher than the plurality of first convex portions in the up/down direction, and the plurality of first convex portions and the plurality of second convex portions may be alternately arranged on the side wall with intervals therebetween in a direction that intersects the up/down direction. By using the cartridge according to this aspect, spaces formed due to the convex portion and the liquid absorber making contact can be made to communicate with each other above the first convex portion, and hence liquid that has seeped out from the liquid absorber can be prevented from existing on only one side of the liquid storage chamber. Therefore, liquid can be effectively prevented from leaking to the outside of the cartridge.

(H1-6) In the cartridge according to the above-described aspect, surfaces of the plurality of first convex portions that face an inner side of the first chamber and surfaces of the plurality of second convex portions that face the inner side of the first chamber at portions higher than the plurality of first convex portions may be located on the same virtual plan. By using the cartridge according to this aspect, the side surface of the liquid absorber can be favorably compressed between the first convex portion and the second convex portion.

(H1-7) In the cartridge according to the above-described aspect, a positioning protrusion used to position the filter may be formed on the bottom portion of the first chamber. By using the cartridge according to this aspect, the filter can be easily fixed to the bottom portion of the first chamber.

(H2-1) According to the second aspect of the disclosure, there is provided a cartridge which is to be mounted onto a liquid jetting apparatus that includes a liquid supply needle. The cartridge includes a liquid supply portion configured to receive the liquid supply needle; a first chamber provided with a liquid absorber; a second chamber not provided with the liquid absorber and provided with the liquid supply portion; and a filter provided between the first chamber and the second chamber. The second chamber includes a liquid guiding passage configured to guide liquid to the liquid supply portion.

By using the cartridge according to this aspect, liquid inside the second chamber can easily flow to the liquid supply portion via the liquid guiding passage. Therefore, even if the second chamber contains bubbles, the bubbles can be prevented from impeding the flow of liquid. As a result, the occurrence of liquid discharge failure can be minimized.

(H2-2) In the cartridge according to the above-described aspect, the second chamber may include a plurality of the liquid guiding passages. By using the cartridge according to this aspect, liquid can be made to flow to the liquid supply portion more favorably.

(H2-3) In the cartridge according to the above-described aspect, the liquid guiding passage may include a first liquid guiding passage formed on a side surface of the second chamber so as to extend from a top portion to a bottom portion. By using the cartridge according to this aspect, liquid can be favorably made to flow from the first chamber to the second chamber.

(H2-4) In the cartridge according to the above-described aspect, the liquid guiding passage may include a second liquid guiding passage formed on a bottom surface of the second chamber so as to extend toward the liquid supply portion in a longitudinal direction of the second chamber. By using the cartridge according to this aspect, liquid inside the second chamber can be favorably made to flow to the liquid supply portion.

(H2-5) In the cartridge according to the above-described aspect, the second liquid guiding passage may be formed of a groove and may have a larger flow passage cross-sectional area closer to the liquid supply portion. By using the cartridge according to this aspect, the liquid can favorably flow to the liquid supply portion because flow passage resistance of the second liquid guiding passage can be reduced.

(H2-6) In the cartridge according to the above-described aspect, the bottom surface of the second chamber may be inclined so as to reduce in height toward the liquid supply portion. By using the cartridge according to this aspect, liquid inside the second chamber can favorably flow to the liquid supply portion.

(H2-7) In the cartridge according to the above-described aspect, the liquid guiding passage may be formed of a groove and/or a rib. By using the cartridge according to this aspect, the liquid guiding passage can easily be formed with a simple structure.

(H2-8) In the cartridge according to the above-described aspect, a distance between at least one portion on an outer peripheral portion of the filter and the bottom surface of the second chamber may be shorter than a distance between another portion of the filter and the bottom surface of the second chamber. By using the cartridge according to this aspect, because bubbles are less likely to enter a portion at which the filter and the bottom surface of the second chamber are close from another portion of the second chamber, liquid can be favorably made to flow from the filter side to the second chamber at the position at which the filter and the bottom surface of the second chamber are close.

(H2-9) In the cartridge according to the above-described aspect, the liquid supply portion may include a valve element configured to open by making contact with the liquid supply needle; a biasing member configured to close the valve element; and a valve chamber in which the valve element and the biasing member are disposed, in which the second chamber may communicate with a top and a side of the valve chamber. By using the cartridge according to this aspect, bubbles inside the second chamber can also enter the valve chamber, and hence the possibility of bubbles being discharged from the liquid supply portion can be reduced.

(H2-10) In the cartridge according to the above-described aspect, the second chamber may be divided into a plurality of spaces by the valve chamber; and each of the plurality of spaces may communicate with each other due to gaps between a top surface of the valve chamber and the filter. By using the cartridge according to this aspect, the space inside the second chamber in which bubbles can exist is made larger, and hence the possibility of bubbles being discharged from the liquid supply portion can be reduced.

(H2-11) In the cartridge according to the above-described aspect, a length of the filter in a longitudinal direction of the filter may be longer than half a length of the liquid absorber in the longitudinal direction. By using the cartridge according to this aspect, a relatively large filter is disposed between the first chamber and the second chamber, and hence liquid can be prevented from accumulating at a portion of the liquid absorber far from the liquid supply portion.

(H2-12) In the cartridge according to the above-described aspect, the filter may be inclined in a horizontal direction. By using the cartridge according to this aspect, because bubbles inside the second chamber travel upward along the inclined filter, the possibility of bubbles being discharged from the liquid supply portion can be reduced.

(H3-1) According the third aspect of the disclosure, there is provided a cartridge which is to be mounted onto a liquid jetting apparatus that includes a liquid supply needle. The cartridge includes a liquid supply portion configured to receive the liquid supply needle; a first chamber provided with a liquid absorber; a second chamber not provided with the liquid absorber and provided with the liquid supply portion; and a filter provided between the first chamber and the second chamber. The second chamber includes a groove portion which connects the filter and a bottom surface of the second chamber to each other. By using the cartridge according to this aspect, liquid inside the second chamber can easily flow to the liquid supply portion through the groove portion. Therefore, even if the second chamber contains bubbles, the bubbles can be prevented from impeding the flow of liquid. In addition, by using the cartridge according to this aspect, liquid inside the second chamber is more likely to be sucked up to the filter side via the groove portion when, for example, air inside the second chamber has expanded. Therefore, liquid can be prevented from being pushed and leaking out from the liquid supply portion due to the air inside the second chamber expanding. Therefore, according to the cartridge of this aspect, the occurrence of liquid discharge failure can be minimized.

(H3-2) In the cartridge according to the above-described aspect, the groove portion may have capillary strength. According to this aspect, liquid can be held in the groove portion, and hence liquid can be reliably prevented from leaking out due to air inside the second chamber expanding.

(H3-3) In the cartridge according to the above-described aspect, the second chamber may include the groove portion at a corner portion of the second chamber. By using the cartridge according to this aspect, the corner portions of the second chamber can be used to more efficiently form the groove portion.

(H3-4) In the cartridge according to the above-described aspect, the groove portion may be narrower closer to the filter. By using the cartridge according to this aspect, the capillary strength of the groove portion can be increased closer to the filter, and hence liquid inside the second chamber can be efficiently sucked up to the filter side when, for example, air inside the second chamber has expanded.

(H3-5) In the cartridge according to the above-described aspect, the groove portion may be configured such that a height at which liquid is sucked up is higher than a height of a portion of the second chamber formed with the groove portion. By using the cartridge according to this aspect, liquid inside the second chamber can be more reliably sucked up to the filter side when, for example, air inside the second chamber has expanded.

(H3-6) In the cartridge according to the above-described aspect, the second chamber may include a plurality of the groove portions. By using the cartridge according to this aspect, the occurrence of liquid discharge failure can be more reliably minimized.

(H3-7) In the cartridge according to the above-described aspect, the bottom surface of the second chamber may include a liquid guiding portion formed so as to extend toward the liquid supply portion in a longitudinal direction of the second chamber. By using the cartridge according to this aspect, liquid inside the second chamber can favorably flow to the liquid supply portion.

(H3-8) In the cartridge according to the above-described aspect, the liquid guiding portion may be formed of a groove and may have a larger flow passage cross-sectional area closer to the liquid supply portion. By using the cartridge according to this aspect, liquid can favorably flow to the liquid supply portion because flow passage resistance of the second liquid guiding passage can be reduced closer to the liquid supply portion.

(H3-9) In the cartridge according to the above-described aspect, the bottom surface of the second chamber may be inclined so as to reduce in height toward the liquid supply portion. By using the cartridge according to this aspect, liquid inside the second chamber can favorably flow to the liquid supply portion.

(H3-10) In the cartridge according to the above-described aspect, a length of the filter in a longitudinal direction of the filter may be longer than half a length of the liquid absorber in the longitudinal direction. By using the cartridge according to this aspect, a relatively large filter is disposed between the first chamber and the second chamber, and hence liquid can be prevented from accumulating at a portion of the liquid absorber far from the liquid supply portion.

The disclosure can be implemented in the form of a variety of different embodiments other than the above-described embodiments as a cartridge. For example, the disclosure can be implemented as a liquid jetting apparatus that includes a cartridge, a liquid jetting system that includes a cartridge and a liquid jetting apparatus, or others.

What is claimed is:

1. A cartridge which is to be mounted onto a liquid jetting apparatus that includes a liquid supply needle, the cartridge comprising:
a liquid supply portion configured to receive the liquid supply needle;
a first chamber provided with a liquid absorber;
a second chamber not provided with the liquid absorber and provided with the liquid supply portion; and
a filter provided between the first chamber and the second chamber,
wherein a length of the filter in a longitudinal direction of the filter is longer than half a length of the liquid absorber in the longitudinal direction.

2. The cartridge according to claim 1, wherein a bottom surface portion of the liquid absorber is compressed more than a central portion of the liquid absorber in a height direction.

3. The cartridge according to claim 1, wherein a cross-sectional area of an internal space along a horizontal direction of the first chamber is smaller on a bottom portion side of the first chamber than a top portion side of the first chamber.

4. The cartridge according to claim 1, wherein:
a convex portion that protrudes inward toward the first chamber is formed on a side wall of the first chamber;
the convex portion extends in an up/down direction; and
the convex portion includes a part inclined so as to protrude further from a top portion to a bottom portion of the first chamber.

5. The cartridge according to claim 1, wherein a positioning protrusion used to position the filter is formed on the bottom portion of the first chamber.

6. A cartridge which is to be mounted onto a liquid jetting apparatus that includes a liquid supply needle, the cartridge comprising:
a liquid supply portion configured to receive the liquid supply needle;
a first chamber provided with a liquid absorber;
a second chamber not provided with the liquid absorber and provided with the liquid supply portion; and
a filter provided between the first chamber and the second chamber,
wherein the second chamber includes a liquid guiding passage configured to guide liquid to the liquid supply portion.

7. The cartridge according to claim 6, wherein the second chamber includes a plurality of the liquid guiding passages.

8. The cartridge according to claim 6, wherein the liquid guiding passage includes a first liquid guiding passage formed on a side surface of the second chamber so as to extend from a top portion to a bottom portion.

9. The cartridge according to claim 6, wherein the liquid guiding passage includes a second liquid guiding passage formed on a bottom surface of the second chamber so as to extend toward the liquid supply portion in a longitudinal direction of the second chamber.

10. The cartridge according to claim 8, wherein the bottom surface of the second chamber is inclined so as to reduce in height toward the liquid supply portion.

11. The cartridge according to claim 6, wherein the liquid guiding passage is formed of a groove and/or a rib.

12. The cartridge according to claim 6, wherein a distance between at least one portion on an outer peripheral portion of the filter and the bottom surface of the second chamber is shorter than a distance between another portion of the filter and the bottom surface of the second chamber.

13. The cartridge according to claim 6, the liquid supply portion comprising:
a valve element configured to open by making contact with the liquid supply needle;
a biasing member configured to close the valve element; and
a valve chamber in which the valve element and the biasing member are disposed,
wherein the second chamber communicates with a top and a side of the valve chamber.

14. A cartridge which is to be mounted onto a liquid jetting apparatus that includes a liquid supply needle, the cartridge comprising:
a liquid supply portion configured to receive the liquid supply needle;
a first chamber provided with a liquid absorber;
a second chamber not provided with the liquid absorber and provided with the liquid supply portion; and
a filter provided between the first chamber and the second chamber,
wherein the second chamber includes a groove portion which connects the filter and a bottom surface of the second chamber to each other.

15. The cartridge according to claim 14, wherein the groove portion has capillary strength.

16. The cartridge according to claim 14, wherein the second chamber includes the groove portion at a corner portion of the second chamber.

17. The cartridge according to claim 14, wherein the groove portion becomes narrower closer to the filter.

18. The cartridge according to claim 14, wherein the groove portion is configured such that a height at which liquid is sucked up is higher than a height of a portion of the second chamber formed with the groove portion.

19. The cartridge according to claim 14, wherein the second chamber includes a plurality of the groove portions.

20. The cartridge according to claim 14, wherein the bottom surface of the second chamber includes a liquid guiding portion formed so as to extend toward the liquid supply portion in a longitudinal direction of the second chamber.
